(19) United States
(12) Patent Application Publication
(10) Pub. No.: US 2023/0252790 A1
(43) Pub. Date: Aug. 10, 2023

(54) SYSTEMS AND METHODS FOR INTELLIGENT INCIDENT MANAGEMENT IN TRANSPORTATION ENVIRONMENTS

(71) Applicant: Rotulu, Inc., Camden, DE (US)

(72) Inventors: David ZICKAFOOSE, Middletown, DE (US); Robert CLOSE, Middletown, DE (US)

(21) Appl. No.: 18/167,605

(22) Filed: Feb. 10, 2023

Related U.S. Application Data
(60) Provisional application No. 63/308,928, filed on Feb. 10, 2022.

(51) Int. Cl. G06V 20/52; G06V 20/59; G06V 10/764; G10L 15/18

(52) U.S. Cl. CPC G06V 20/52; G06V 20/59; G06V 10/764; G10L 15/18

(57) ABSTRACT

Systems and methods are provided for an incident management system that provide for detection, reporting, and processing for a various incident types that occur in connection to a school bus environment. The disclosed systems and methods can be leveraged to recognize conditions occurring in a school bus environment, classify the conditions as a candidate incident, such as incidents occurring between student passenger. The candidate incident can be used to generate an incident report. In an example implementation, sensors associated with areas of a bus cabin may are used to detect events, categorize the events as candidate incidents, and identify suspected student participants of the candidate incidents based on the areas to the sensors.

### BACKGROUND

A significant number of students utilize school bus systems for commuting to and from school. Often there is little supervision of students during travel, as the bus driver's focus is primarily on the road ahead. Undesired incidents can often occur within this environment, which may go unnoticed and/or unaddressed. Some such incidents may be behavior related, including incidents such as bullying, harassment, threatening behavior, drug usage or transactions, offensive language such as racial slurs, physical altercations, and the like. Other such incidents may be environment related, including incidents such as a bus accident, a malfunctions or concerns with vehicle operation, and the like. Still further such incidents may be related to other issues, or be indicative of other issues, including incidents when a particular child should be on the bus at a particular time but is not, when a certain number of children should have exited the bus at a particular stop but did not, and the like. With many events being possible during this uniquely less supervised time on the bus between home and school, the physical, emotional, and mental safety of the students while riding the bus is a growing concern.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1A is a schematic representation of an example school bus with which embodiments of the systems and methods disclosed herein may be implemented.

FIGS. 1B-1D illustrate schematic diagrams of example passenger sensors and associated areas of an interior cabin of the school bus of FIG. 1A according to embodiments disclosed herein.

FIG. 2 illustrates an example architecture for incident detection in accordance with embodiments of the systems and methods described herein.

FIG. 3A is an example network architecture of an incident detection and management system in accordance with various embodiments disclosed herein.

FIG. 3B is another example network architecture of an incident detection and management system in accordance with embodiments disclosed herein.

FIG. 4 is a flow chart illustrating example operations for authenticating end-user devices on the incident detection and management system of FIGS. 3A and/or 3B in accordance with various embodiments disclosed herein.

FIGS. 5A-5D is a block diagram of an example incident data model in accordance with embodiments disclosed herein.

FIGS. 5E-5H is a block diagram of another example incident data model in accordance with embodiments disclosed herein.

FIG. 6 is a block diagram of an example end-user roles data model in accordance with embodiments disclosed herein.

FIG. 7 illustrates a schematic hierarchical tree diagram of a school bus service market place in which embodiments of the disclosed technology can be implemented.

FIG. 8 is a process flow illustrating example operations for generating a candidate incident report in accordance with various embodiments disclosed herein.

FIG. 9 is a process flow illustrating example operations of incident detection in accordance with various embodiments disclosed herein.

FIGS. 10A-10E illustrate screen shots of an example graphical user interface that may be generated in accordance with embodiments disclosed herein.

FIG. 11 is an example computing component that may be used to implement various features of embodiments described in the present disclosure.

The figures are not exhaustive and do not limit the present disclosure to the precise form disclosed.

### DETAILED DESCRIPTION

Embodiments disclosed herein provide an incident management system that provide for incident detection, reporting, and processing for a various incident types that occur in connection to a school bus environment. The embodiments disclosed herein can be leveraged to recognize conditions occurring in a school bus environment, classify the conditions as a candidate incident occurring between passenger participants that can be used to generate an incident report. Further, embodiments disclosed herein can provide insight into the progression of the candidate incident through its life cycle from occurrence to resolution. Furthermore, embodiments disclosed herein can provide for an ability to configure the incident life cycle specific to an organization, assign actors and contact information at the various phases, and provide aggregate data visualizations.

The American Public Health Association (APHA) has found increases in violent incidents that occur on school buses, such as verbal, physical, emotional, and sexual violence between students. According to various surveys, school buses are the second most likely location wherein a student may encounter bullying and/or harassment. The Publish School Parent's Network has reported that the school buses may be a potentially volatile environment where a number of student passengers are placed within a confined interior cabin, with limited supervision, and little protection.

Conventionally, the only supervision present on a school bus is the bus driver (also referred to as an operator). In limited cases, an aide may also be present. The bus driver must divide his/her attention between driving the bus safely (especially in inclement weather or traffic conditions) along an assigned route and ensuring safety of the student passengers that are riding the bus. With so many student passengers placed within a confined space for an extended period of time and the bus driver forced to focus on the road, outbreaks of student misbehavior is likely to increase. While bus drivers are required to obtain a chauffeur's license and pass background evaluations, even in situations where they do detect an incident (e.g., a behavioral incident), most bus drivers are not provided with behavior management training, which can be nuanced for youth from differing backgrounds.

Furthermore, conventionally, bus drivers had to rely on a rear-view mirrors that contain the interior cabin in the field of view and the bus drivers own hearing. In many instances, misbehaviors may be visually obscured due to the limited field of view afforded to the bus driver. For example, the bus driver generally uses a quick visual scan of the interior cabin using the mirror, and high seat backs or other students may block the line of sight of potential misbehaviors. Indeed, even if the driver could devote full attention to the student passengers (which he/she cannot do while driving), the nature of the seating structures in the bus environment and their position/orientation relative to the bus driver's seating position/orientation precludes the bus driver from observing many incidents that occur within the cabin. Furthermore, giving the limited time that the bus driver can spend on scanning the interior (e.g., as a result of divided attention), the bus driver may not adequately recognize inappropriate behaviors and/or events that could lead up to a violent confrontation (e.g., escalating arguments). While the bus driver may also rely on listening for misbehaviors to some extent, such methods are subject to various impairments, such as but not limited to, misinterpretation, confusion due to overlapping sounds (e.g., noises, voices, bus operations, etc.), diminished hearing ability of the driver, etc. Particularly in the case of the back of the bus, where misbehavior may be more likely to occur, the impaired hearing environment reduces the bus driver's ability to recognize misbehaviors and take remedial actions. Often the sheer number of students talking at one time further complicates the hearing environment. As a result, bus drivers are generally not well equipped or prepared to deal with potential incidents that can arise amidst groups of student passengers.

Embodiments disclosed herein provide for an incident detection and management system that can be installed on a school bus for intelligent detection of potential, candidate incidents occurring between student passengers situated within this unique travel environment. Although the examples in the disclosure herein are directed to school buses in particular, embodiments of the disclosed technology may be applied in other environments with similar attributes, such a city bus, a tour bus, a trolley, a train car, a limousine, subway train, or other vehicles with elongate cabins having several rows of seating for volume transport.

Embodiments herein provided for a plurality of sensors disposed throughout an interior cabin. Each sensor is associated with an area of the interior cabin, such as one or more seats of a school bus. As a result, the entire interior may be monitored by monitoring passengers situated within or near the vicinity of such seat. Sensors may be provided as audio sensors (e.g., microphones), motion sensors, image sensors (e.g., cameras, IR sensors, and the like), electro-chemical sensors (e.g., drug detectors, smoke detectors and the like), any other type of sensor, or a combination thereof. Sensors may detect conditions related to each assigned area to detect an occurrence of an event, and the embodiments disclosed herein may classify the event as a candidate incident if a characteristics or attribute of the detected condition exceeds a threshold value.

In an illustrative embodiment, electro-chemical sensors may detect unique light scattering signatures associated with particulates of cocaine, opioids, marijuana, or other drugs in the vicinity of a particular seat. Embodiments disclosed herein can then determine a location of the candidate incident by identifying the sensor that detected the highest concentration (or any concentration) of drug from which an associated area (e.g., seat) can be retrieved. Embodiments disclosed herein can leverage this location to identify one or more student passengers as suspected participants (e.g., based on a seating arrangement, a correlated time-stamped image from the video sensors).

In another illustrative embodiment, audio sensors may detect sounds emitting from each seat. Confrontations between students may involve increases in amplitude or frequency of the sounds, which may be leveraged to classify the detected sounds a candidate incident. Embodiments disclosed herein can then determine a location of the candidate incident by identifying the sensor that detected the event from which an associated area (e.g., seat) can be retrieved. Embodiments disclosed herein can leverage this location to identify one or more student passengers as suspected participants.

Moreover, embodiments disclosed herein can generate an incident report of a candidate incident. For example, an incident report can be created from end-user inputs into a graphical user interface (GUI) on a web-based application and/or mobile application. Incident reports may also be created through the automated candidate incident detection system, including as described by way of example herein. Creation of an incident report triggers an incident life cycle for submitting and resolving the candidate incident. For example, the incident report can be provided to actors and/or systems that can provide additional information and/or used in recommending resolution actions for the candidate incident. The provided incident report can then be automatically forwarded to a next phase after each actor and/or system performs its assigned tasks. The life cycle ends when the candidate incident is assigned back to the creator of the incident, who acknowledges that resolution actions.

According to various embodiments disclosed herein, data on a number of candidate incidents can be collected and categorized to build predictive machine learning algorithms that can assign probabilities to detected events for modeling and/or forecasting candidate incidents given a set of constraints (e.g., constraints specific to the particular set of students, the particular bus route, the time of day, etc.). Thus, by detecting escalating events, incidents can be prevented from occurring in the future. For example, school bus monitoring, such through event detection and visual processing, can be used to detect events within a school bus environment. The events can be correlated with incidents, from which probabilities derived that a given event corresponds to an incident. The predictive algorithms and probabilities can then be stored in a database and used for predicting an incident occurrence based on detected events.

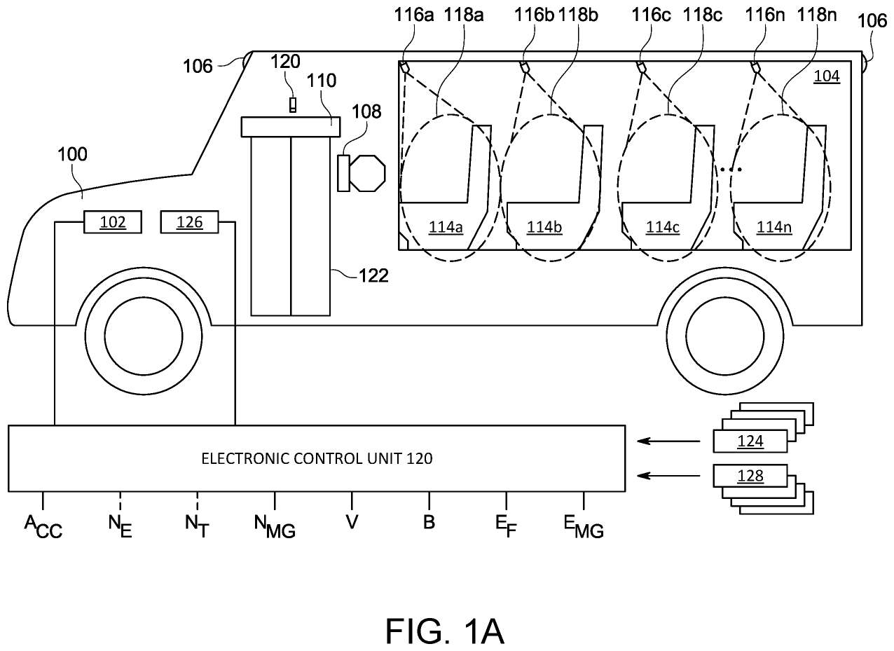

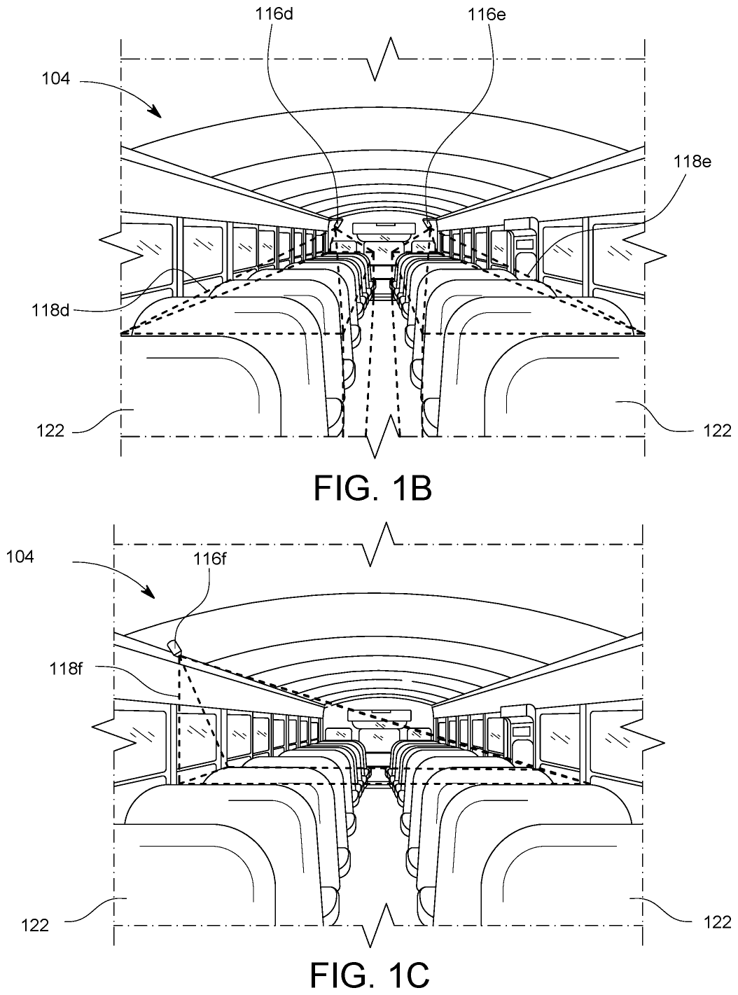

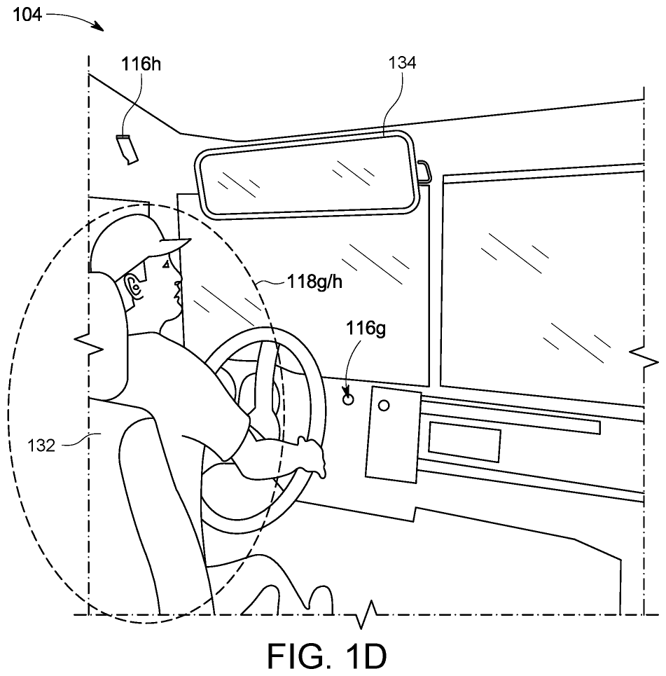

The systems and methods disclosed herein may be implemented with any of a number of different vehicles and vehicle types. For example, the systems and methods disclosed herein may be used with automobiles, trucks, buses, recreational vehicles and other like on-or off-road vehicles. In addition, the principals disclosed herein may also extend to other vehicle types as well. An example, school bus in which embodiments of the disclosed technology may be implemented is illustrated in FIG. 1A. Although the example described with reference to FIG. 1A is a school bus, the systems and methods disclosed herein can be implemented in other types of vehicles. Particular embodiments of the disclosed technology may be successfully applied with in vehicles with elongate cabins having several rows of seating for volume transport.

FIG. 1A illustrates an example vehicle 100 (illustratively depicted as a school bus) that may include a propulsion system 102, such as internal combustion engine and/or one or more electric motors as sources of motive power. Driving force generated by the internal propulsion system can be transmitted to one or more wheels for travel.

The vehicle 100 may further include one or more output devices. Output devices may include lights 106 for notifying nearby drivers, a sign actuator 108 for deploying a stop sign, which may also comprise lights, and a door actuator 110 for opening and closing door 122. In embodiments where the vehicle 100 is a conventional passenger vehicle, the door actuator 110 may be replaced with a lock actuator such that passengers manually open and close the door 122.

The vehicle 100 may further include an interior space or cabin 104. The cabin 104 comprises a plurality of seats 114a-114n (collectively referred to herein as seats 114) for carrying passengers. In the case of a school bus, seats 114 can carry student passengers. In some examples, the seats 114 may be arranged in two columns and a number of rows. Each seat 114 may be provided to carry one or more passengers.

The vehicle 100 may also include a plurality of passenger sensors 116a-116n (collectively referred to herein as passenger sensors 116) disposed within the cabin 104. Each passenger sensor 116 may correspond to an area 118a-118n (collectively referred to herein as areas 118) within the cabin 104 such that each passenger sensor 116 detect events or conditions within the corresponding area of the interior associated with each sensor. Passenger sensors 116 may be provided as audio sensors for detecting sounds emitting nearby, such as within 3D areas reflected by the dashed lines associated with corresponding areas 118 (e.g., dynamic microphone, carbon microphone, ribbon microphone, and piezoelectric microphone, and the like), for example; motion sensors for detecting nearby motion, such as within areas 118 (e.g., Passive Infrared (PIR), Microwave, and Dual Tech/Hybrid, and the like), for example; image sensors for capturing image data (e.g., cameras for capturing a plurality of image frames) of the corresponding areas 118, for example; or a combination thereof.

In the illustrative example of FIG. 1A, each area 118 corresponds to a seat 114. That is, for example, each passenger sensors 116 may detect conditions within an area that comprises all or a portion of a seat 114 (e.g., passenger sensor 116a detects conditions from seat 114a). For example, in the case a passenger sensor 116 is an audio sensor, each passenger sensor 116 can detect sounds from an area of a corresponding seat 114. Sounds may include voices of passengers or sounds resulting from objects interacting (e.g., fighting, objects thrown that contact passengers, etc.). In another example, where a passenger sensor 116 is a motion sensor, passenger sensor 116 can detect motion within an area 118 corresponding to a seat. For example, movement of passengers entering/exiting a seat, movement from body parts (e.g., movement of arms, legs, etc.), movement of objects, and the like. In yet another example, where a passenger sensor 116 is an image sensor, passenger sensor 116 can capture image data as sequential video frames of the area 118 including the seat.

The number of passenger sensors 116 need not be the same as the number of seats 114. For example, passenger sensors 116 may correspond to a row of seats, a column of seats, or combinations thereof. FIG. 1B illustrates a schematic diagram of passenger sensors 116d and 116e associated with column areas 118d and 118e, respectively. Thus, in the example of FIG. 1B, passengers sensors 116d and 116f may detect conditions of seats 114 included within a respective column. FIG. 1C illustrates another schematic diagram of passenger sensor 116f associated with row area 118f. Thus, in the example of FIG. 1C, passengers sensor 116f may detect conditions of seats 114 within row area 118f. In this manner, events occurring in the cabin 104 may be detected using one or more passenger sensors 116.

In FIGS. 1B and 1C, certain numbers of passenger sensors 116 are show for illustrative purposes, and more or fewer passenger sensors 116 may be included. For example, a number of passenger sensors 116 may be provided on the same, different, alternating, etc. sides of the cabin 104, each corresponding to a respective row of seats. Thus, a passenger sensors 116 may be associated with each row. With respect to FIG. 1C, passenger sensors 116 may be associated with portions of each column, whereby each portion comprises a subset of the seats of each column.

FIG. 1D is another schematic diagram illustrating a front section of cabin 104, which includes a driver seat 132 that can support a bus driver. FIG. 1D also shows an example of rear-view mirror 134 that a bus driver may use for monitoring passenger behavior. However, as noted above, the driver may not be able to adequately monitor passenger behavior through rear-view mirror 134 (and/or bus driver hearing). In the example implementation of FIG. 1D, passenger sensors 116 may include one or more of passenger sensors 116g and 116h. Passenger sensors 116g and/or passenger sensors 116h may be associated with area 118g/h comparing the driver seat 132. In this way, conditions from driver seat 132 may be detected using on or more of passenger sensors 116g and 116h. In some examples, passenger sensors 116g and/or 116h may also be associated with one or more seats 114 located behind the driver seat 132. In another example, alone or in combination, one or more of passenger sensors 116g and 116h may be used to detect conditions from the doorway.

Vehicle 100 may also include a door sensor 120, in some examples. The door sensor 120 may be positioned internally or externally such that the door sensor 120 has detects conditions from a region extending up to and possibly including door 122. In this manner, a passenger standing outside the door 122 may be identified and/or events occurring within the doorway may be detected. The door sensor 120 may be similar to passenger sensors 116.

Vehicle 100 include an electronic control unit 130. Electronic control unit 130 may include circuitry to control various aspects of the vehicle operation. Electronic control unit 130 may include, for example, a microcomputer that includes a one or more processing units (e.g., microprocessors), memory storage (e.g., RAM, ROM, etc.), and I/O devices. The processing units of electronic control unit 130, execute instructions stored in memory to control one or more electrical systems or subsystems 126 in the vehicle. Electronic control unit 130 can include a plurality of electronic control units such as, for example, an electronic engine control module, a powertrain control module, a transmission control module, a suspension control module, a body control module, and so on. As a further example, electronic control units can be included to control systems and functions such as doors and door locking (e.g., actuators 108 and 110), lighting, human-machine interfaces, cruise control, telematics, braking systems (e.g., ABS or ESC), battery management systems, and so on. These various control units can be implemented using two or more separate electronic control units, or using a single electronic control unit.

In the example illustrated in FIG. 1A, electronic control unit 130 receives information from one or more sensors included in vehicle 100. For example, electronic control unit 130 may receive signals that indicate vehicle operating conditions or characteristics, or signals that can be used to derive vehicle operating conditions or characteristics. These may include, but are not limited to accelerator operation amount, ACC, a revolution speed, NE, of internal combustion engine (engine RPM), a rotational speed, NMG, of the motor (motor rotational speed), and vehicle speed, NV. These may also include torque converter output, NT (e.g., output amps indicative of motor output), brake operation amount/pressure, B, battery SOC (i.e., the charged amount for battery detected by an SOC sensor). Accordingly, vehicle 100 can include a plurality of vehicle sensors 124 that can be used to detect various operating conditions of the vehicle and provide sensed conditions to electronic control unit 130 (which, again, may be implemented as one or a plurality of individual control circuits). In one embodiment, sensors 124 may be included to detect one or more conditions directly or indirectly such as, for example, fuel efficiency, EF, motor efficiency, EMG, hybrid (internal combustion engine and motors, where applicable) efficiency, acceleration, ACC, etc.

In some embodiments, one or more of the sensors 124 may include their own processing capability to compute the results for additional information that can be provided to electronic control unit 130. In other embodiments, one or more sensors may be data-gathering-only sensors that provide only raw data to electronic control unit 130. In further embodiments, hybrid sensors may be included that provide a combination of raw data and processed data to electronic control unit 130. Sensors 124 may provide an analog output or a digital output.

As described above, additional sensors may be included to detect not only the operating conditions of the vehicle, but also non-operating conditions as well, such as activities or events occurring internal or external to the vehicle 100. Certain sensors, including 120, might be provided to detect conditions that are external to the vehicle. These sensors can include, for example, sonar, radar, lidar or other vehicle proximity sensors, and cameras or other image sensors. Image sensors can be used to detect objects in an environment surrounding vehicle 100, for example, traffic signs indicating a current speed limit, road curvature, obstacles, surrounding vehicles, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

Furthermore, passenger sensors 116 are provided to detect conditions that are internal to the vehicle, such as inside cabin 104. Passenger sensors 116 used to detect sounds from passengers, movement of passengers and/or objects (e.g., articles, items, etc.) within cabin 104, capture image data of conditions in cabin 104, and so on. The passenger sensors 116 may detect internal conditions and generate sensed signal 128 to electronic control unit 130. The sensed signal 128 can reflect one or more characteristics of the conditions sensed from the corresponding area 118. For example, in the case audio sensors, the sensed signal 128 may comprise characteristics of sounds detected, such as amplitude, frequency, timber, envelope, velocity, and so on. In the case of image sensors, the characteristics may comprise image data in the form of sequential image frames comprising pixel information (e.g., RGB per pixel for cameras). In the case of motion sensors, the characteristics may comprise velocity, acceleration, and direction in a Cartesian coordinate system. The electronic control unit 130 can include instructions to detect an event from the sensed signals 128 and classify the event as a candidate incident between passengers of the vehicle 100 based on one or more characteristics of the sensed signal 128 exceeding a threshold value. For example, in the case of audio sensors, an event may be classified as a candidate even if the amplitude exceeds a threshold value. Other implementations are possible, and further details and examples are provided herein. Electronic control unit 130 can also use the sensed signal 128 to determine a location of the candidate incident based on an association between the passenger sensors 116 that generated the sensed signal and the areas 118 corresponding thereto. Based, in part, on the determined location, electronic control unit 130 can identify one or more student passengers as suspected participant of the candidate incident. For example, a student passenger located within the area 118 may be considered a suspected participant in (or a possible first-hand witness to) the candidate incident.

The example of FIGS. 1A-1D is provided for illustration purposes only as one example of vehicle systems with which embodiments of the disclosed technology may be implemented. One of ordinary skill in the art reading this description will understand how the disclosed embodiments can be implemented with this and other vehicle platforms.

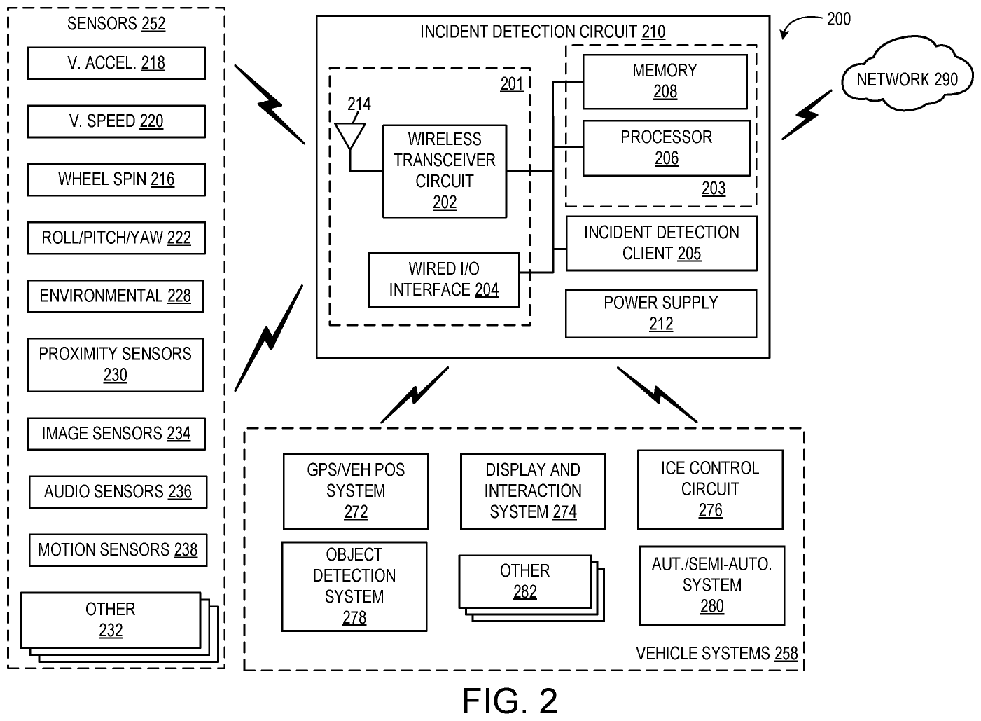

FIG. 2 illustrates an example architecture for incident detection in accordance with embodiments of the systems and methods described herein. Referring now to FIG. 2, in this example, incident detection system 200 includes an incident detection circuit 210, a plurality of sensors 252 and a plurality of vehicle systems 258. Sensors 252 (such as vehicle sensors 124, passenger sensors 116, and/or door sensor 120 described in connection with FIG. 1A) and vehicle systems 258 (such as subsystems 126 described in connection with FIG. 1A) can communicate with incident detection circuit 210 via a wired or wireless communication interface. Although sensors 252 and vehicle systems 258 are depicted as communicating with incident detection circuit 210, they can also communicate with each other as well as with other vehicle systems. incident detection circuit 210 can be implemented as an ECU or as part of an ECU such as, for example electronic control unit 130. In other embodiments, incident detection circuit 210 can be implemented independently of the ECU.

Incident detection circuit 210 in this example includes a communication circuit 201, a decision circuit 203 (including a processor 206 and memory 208 in this example) and a power supply 212. Components of incident detection circuit 210 are illustrated as communicating with each other via a data bus, although other communication in interfaces can be included. Incident detection circuit 210 in this example also includes incident detection client 205 that can be operated to connect to an edge server of a network 290 to contribute to incident detection and reporting.

Processor 206 can include one or more GPUs, CPUs, microprocessors, or any other suitable processing system. Processor 206 may include a single core or multicore processors. The memory 208 may include one or more various forms of memory or data storage (e.g., flash, RAM, etc.) that may be used to store instructions and variables for processor 206 as well as any other suitable information, such as, one or more of the following elements: position data; vehicle speed data; risk and mitigation data, sensor data, along with other data as needed. Memory 208 can be made up of one or more modules of one or more different types of memory, and may be configured to store data and other information as well as operational instructions that may be used by the processor 206 to incident detection circuit 210.

Although the example of FIG. 2 is illustrated using processor and memory circuitry, as described below with reference to circuits disclosed herein, decision circuit 203 can be implemented utilizing any form of circuitry including, for example, hardware, software, or a combination thereof. By way of further example, one or more processors, controllers, ASICs, PLAs, PALs, CPLDs, FPGAs, logical components, software routines or other mechanisms might be implemented to make up an incident detection circuit 210.

Communication circuit 201 includes either or both a wireless transceiver circuit 202 with an associated antenna 214 and a wired I/O interface 204 with an associated hardwired data port (not illustrated). Communication circuit 201 can provide for vehicle-to-everything (V2X) and/or vehicle-to-vehicle (V2V) communications capabilities, allowing incident detection circuit 210 to communicate with edge devices, network cloud servers and cloud-based databases, and/or other vehicles via network 290. For example, V2X communication capabilities allows incident detection circuit 210 to communicate with edge/cloud servers, roadside infrastructure (e.g., such as roadside equipment/roadside unit, which may be a vehicle-to-infrastructure (V2I)-enabled street light or cameras, for example), etc. incident detection circuit 210 may also communicate with other connected vehicles over vehicle-to-vehicle (V2V) communications.

As this example illustrates, communications with incident detection circuit 210 can include either or both wired and wireless communications circuits 201. Wireless transceiver circuit 202 can include a transmitter and a receiver (not shown) to allow wireless communications via any of a number of communication protocols such as, for example, Wi-Fi, Bluetooth, near field communications (NFC), Zigbee, and any of a number of other wireless communication protocols whether standardized, proprietary, open, point-to-point, networked or otherwise. Antenna 214 is coupled to wireless transceiver circuit 202 and is used by wireless transceiver circuit 202 to transmit radio signals wirelessly to wireless equipment with which it is connected and to receive radio signals as well. These RF signals can include information of almost any sort that is sent or received by incident detection circuit 210 to/from other entities such as sensors 252 and vehicle systems 258.

Wired I/O interface 204 can include a transmitter and a receiver (not shown) for hardwired communications with other devices. For example, wired I/O interface 204 can provide a hardwired interface to other components, including sensors 252 and vehicle systems 258. Wired I/O interface 204 can communicate with other devices using Ethernet or any of a number of other wired communication protocols whether standardized, proprietary, open, point-to-point, networked or otherwise.

Power supply 212 can include one or more of a battery or batteries (such as, e.g., Li-ion, Li-Polymer, NiMH, NiCd, NiZn, and NiH2, to name a few, whether rechargeable or primary batteries,), a power connector (e.g., to connect to vehicle supplied power, etc.), an energy harvester (e.g., solar cells, piezoelectric system, etc.), or it can include any other suitable power supply.

Sensors 252 can include, for example, vehicle sensors 124, passenger sensors 116, and door sensor 120 such as those described above with reference to the example of FIG. 1A. Sensors 252 can include additional sensors that may or may not otherwise be included on a standard vehicle with which the incident detection system 200 is implemented. In the illustrated example, sensors 252 include vehicle acceleration sensors 218, vehicle speed sensors 220, wheelspin sensors 216 (e.g., one for each wheel), accelerometers such as a 2-axis accelerometer 222 to detect roll, pitch and yaw of the vehicle, environmental sensors 228 (e.g., to detect salinity or other environmental conditions), and proximity sensor 230 (e.g., sonar, radar, lidar or other vehicle proximity sensors). Additional sensors 232 can also be included as may be appropriate for a given implementation of incident detection system 200.

System 200 may be equipped with one or more image sensors 234. These may include front facing image sensors, side facing image sensors, and/or rear facing image sensors implemented as, for example, vehicle sensors 124 and/or door sensor 120. Image sensors may capture information which may be used in detecting not only vehicle conditions but also detecting conditions external to the vehicle as well. Image sensors that might be used to detect external conditions can include, for example, cameras or other image sensors configured to capture data in the form of sequential image frames forming a video in the visible spectrum, near infra-red (IR) spectrum, IR spectrum, ultra violet spectrum, etc. Image sensors 234 can be used to, for example, to detect objects in an environment surrounding a vehicle comprising incident detection system 200, for example, surrounding vehicles, roadway environment, road lanes, road curvature, obstacles, and so on. For example, a one or more image sensors 234 may capture images of surrounding vehicles in the surrounding environment. As another example, object detecting and recognition techniques may be used to detect objects and environmental conditions, such as, but not limited to, road conditions, surrounding vehicle behavior (e.g., driving behavior and the like), and the like. Additionally, sensors may estimate proximity between vehicles. For instance, the image sensors 234 may include cameras that may be used with and/or integrated with other proximity sensors 230 such as LIDAR sensors or any other sensors capable of capturing a distance. As used herein, a sensor set of a vehicle may refer to sensors 252.

Image sensors 234 may also include interior image sensors, for example, implemented as passenger sensors 116. Image sensors 234 may capture information which may be used in detecting conditions internal to the vehicle. Image sensors 234 can be used to, for example, to detect events in an environment inside a vehicle comprising incident detection system 200, for example, in the cabin 104. For example, a one or more image sensors 234 may capture images of an associated area (e.g., associated area 118) in the cabin 104. As another example, object detecting and recognition techniques may be used to detect events and internal conditions, such as, but not limited to, passenger behavior (e.g., arguments, fights, and the like), thrown objects, and the like.

System 200 may be equipped with one or more audio sensors 236. Audio sensors 236 may also include audio sensors, for example, implemented as passenger sensors 116 and/or door sensor 120. These audio sensors may capture information which may be used in detecting conditions internal and/or external to the vehicle. Audio sensors that might be used to detect conditions can include, for example, microphones (e.g., dynamic microphones, carbon microphones, ribbon microphones, and piezoelectric microphones, and the like) or other audio sensors configured to capture data in the form of sound having a frequency, amplitude timber, envelope, velocity, and so on. Audio sensors 236 can be used to, for example, to detect audio related events in an environment inside and/or external to a vehicle comprising incident detection system 200. For example, a one or more audio sensors 236 may capture sound emitting from an associated area (e.g., associated area 118) in the cabin 104.

System 200 may be equipped with one or more motion sensors 238. Motion sensors 236 may also include motion sensors, for example, implemented as passenger sensors 116 and/or door sensor 120. These motion sensors may capture information which may be used in detecting conditions internal and/or external to the vehicle. Audio sensors that might be used to detect conditions can include, for example, passive infrared sensor, microwave sensor, dual technology motion sensor, area reflective sensor, ultrasonic sensor, vibration motion sensor, contact sensor, video motion sensor (e.g., using one or more image sensors 234) or other motion sensors configured to capture data in the form of movement of passengers and/or objects having a velocity, acceleration, and direction in a Cartesian coordinate system. Motion sensors 238 can be used to, for example, to detect movement related events in an environment inside and/or external to a vehicle comprising incident detection system 200. For example, a one or more motion sensors 238 may capture movement within an associated area (e.g., associated area 118) in the cabin 104.

Vehicle systems 258, for example, systems and subsystems 126 described above with reference to the example of FIG. 1A, can include any of a number of different vehicle components or subsystems used to control or monitor various aspects of the vehicle and its performance. In this example, the vehicle systems 258 includes a vehicle positioning system 272 (e.g., a global positioning system (GPS), triangulation system, dead-reckoning system, and/or similar systems for determining geographic positions of the vehicle); engine control circuits 276 to control the operation of engine (e.g., propulsion system 102); object detection system 278 to perform image processing such as object recognition and detection on images from image sensors 234, proximity estimation, for example, from image sensors 234 and/or proximity sensors, etc. for use in other vehicle systems; vehicle display and interaction system 274 (e.g., vehicle audio system for broadcasting notifications over one or more vehicle speakers), vehicle display system and/or the vehicle dashboard system), and other vehicle systems 282 (e.g., Advanced Driver-Assistance Systems (ADAS), autonomous or semi-autonomous driving systems 280, such as forward/rear collision detection and warning systems, pedestrian detection systems, autonomous or semi-autonomous driving systems, and the like).

Network 290 may be a conventional type of network, wired or wireless, and may have numerous different configurations including a star configuration, token ring configuration, or other configurations. Furthermore, the network 290 may include a local area network (LAN), a wide area network (WAN) (e.g., the Internet), or other interconnected data paths across which multiple devices and/or entities may communicate. In some embodiments, the network may include a peer-to-peer network. The network may also be coupled to or may include portions of a telecommunications network for sending data in a variety of different communication protocols. In some embodiments, the network 290 includes Bluetooth® communication networks or a cellular communications network for sending and receiving data including via short messaging service (SMS), multimedia messaging service (MMS), hypertext transfer protocol (HTTP), direct data connection, wireless application protocol (WAP), e-mail, DSRC, full-duplex wireless communication, mmWave, Wi-Fi (infrastructure mode), Wi-Fi (ad-hoc mode), visible light communication, TV white space communication and satellite communication. The network may also include a mobile data network that may include 3G, 4G, 5G, LTE, LTE-V2V, LTE-V2I, LTE-V2X, LTE-D2D, VoLTE, 5G-V2X or any other mobile data network or combination of mobile data networks. Further, the network 290 may include one or more IEEE 802.11 wireless networks.

In some embodiments, the network 290 includes a V2X network (e.g., a V2X wireless network). The V2X network is a communication network that enables entities such as elements of the operating environment to wirelessly communicate with one another via one or more of the following: Wi-Fi; cellular communication including 3G, 4G, LTE, 5G, etc.; Dedicated Short Range Communication (DSRC); millimeter wave communication; etc. As described herein, examples of V2X communications include, but are not limited to, one or more of the following: Dedicated Short Range Communication (DSRC) (including Basic Safety Messages (BSMs) and Personal Safety Messages (PSMs), among other types of DSRC communication); Long-Term Evolution (LTE); millimeter wave (mmWave) communication; 3G; 4G; 5G; LTE-V2X; 5G-V2X; LTE-Vehicle-to-Vehicle (LTE-V2V); LTE-Device-to-Device (LTE-D2D); Voice over LTE (VoLTE); etc. In some examples, the V2X communications can include V2V communications, Vehicle-to-Infrastructure (V2I) communications, Vehicle-to-Network (V2N) communications or any combination thereof.

Examples of a wireless message (e.g., a V2X wireless message) described herein include, but are not limited to, the following messages: a Dedicated Short Range Communication (DSRC) message; a Basic Safety Message (BSM); a Long-Term Evolution (LTE) message; an LTE-V2X message (e.g., an LTE-Vehicle-to-Vehicle (LTE-V2V) message, an LTE-Vehicle-to-Infrastructure (LTE-V2I) message, an LTE-V2N message, etc.); a 5G-V2X message; and a millimeter wave message, etc.

In an example implementation, incident detection circuit 210 may receive data in the form of sensed signals (e.g., sensed signal 128 of FIG. 1A) from sensors 252 (e.g., passenger sensors 116) detecting conditions within associated areas of the vehicle. For example, areas 118 in the case of sensors 252 implemented as passenger sensors 116, and doorway adjacent in the case of sensors 252 implemented as door sensor 120. From the detected conditions, incident detection circuit 210 may determine an occurrence of an event and classify the detected event as a candidate incident based on the sensed signals. For example, if one or more characteristics (e.g., amplitude, frequency, etc. in the case of audio events) exceeds a threshold value, incident detection circuit 210 determines the detected event is a candidate incident, such as escalating sounds that may indicate and/or result in physical altercations, an actual physical altercation, throwing objects, or the like. The incident detection circuit 210 can determine a location for the candidate incident using one or more sensors 252 that detected the conditions to identify one or more area (e.g., areas 118) associated with the one or more sensors 252. Based, in part, on the identified location, incident detection circuit 210 may identify one or more passengers as suspected participants of the candidate incident. In one implementation, the incident detection client 205 may share information of the candidate incident, including the suspected participants, to a cloud-based or edge server using communication circuit 201 via network 290. In another implementation, the incident detection circuit 210 may generate an incident report from the information of the candidate incident, which can be shared to the cloud/edge sever via network 290 for use in an incident reporting and resolution system. In yet another implementation, incident detection circuit 210 may generate an incident report and an incident resolution action for the incident report, which can be shared to the cloud/edge server via network 290.

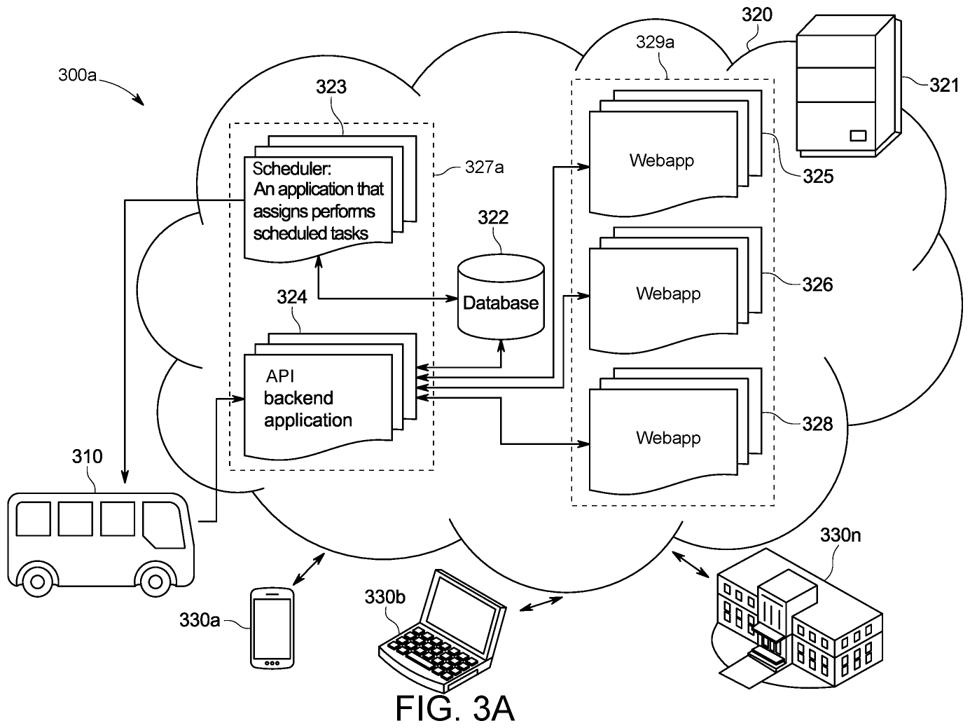

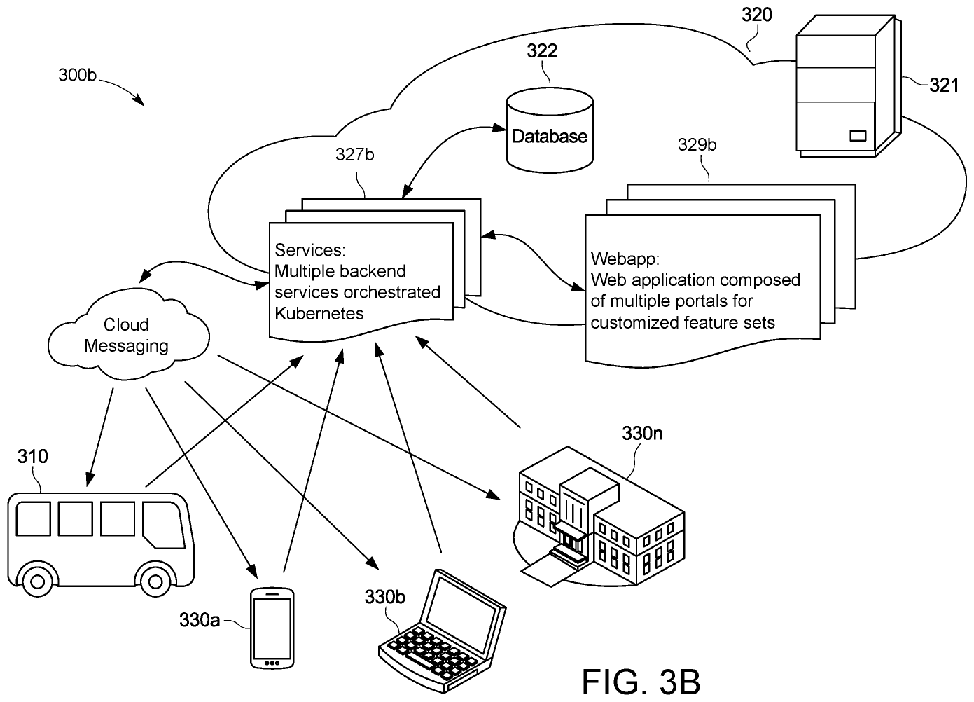

Embodiments disclosed herein combine cloud native applications executed on a cloud-based server, mobile applications running on school buses and/or end-user devices, and hardware components to facilitate communication, data acquisition, and analytics for each school bus. FIG. 3A is an example network architecture 300a of an incident detection, reporting, and resolution system in accordance with various embodiments disclosed herein. The architecture 300a includes an incident management system 320, one or more vehicles 310, and a plurality of end-users device 330a-330n (collectively referred to herein as end-users 330). The server 321, vehicle 310, and end-user devices 330 can all communicate with one another in this example, through a network (e.g., network 290 of FIG. 2).

One or more vehicle 310 may be implemented, for example, as vehicle 100 of FIG. 1A (e.g., a school bus) comprising incident detection circuit 210 of FIG. 2. As described above, incident detection circuit 210 may communicate with cloud/edge servers using incident detection client 205 via network 290. Accordingly, one or more vehicles 310 of FIG. 3A may include incident detection client 205 for communicating with incident management system 320. For example, as described above, server 321 may share information with incident management system 320, such as but not limited to, candidate incidents, suspected participants, and incident reports, where applicable.

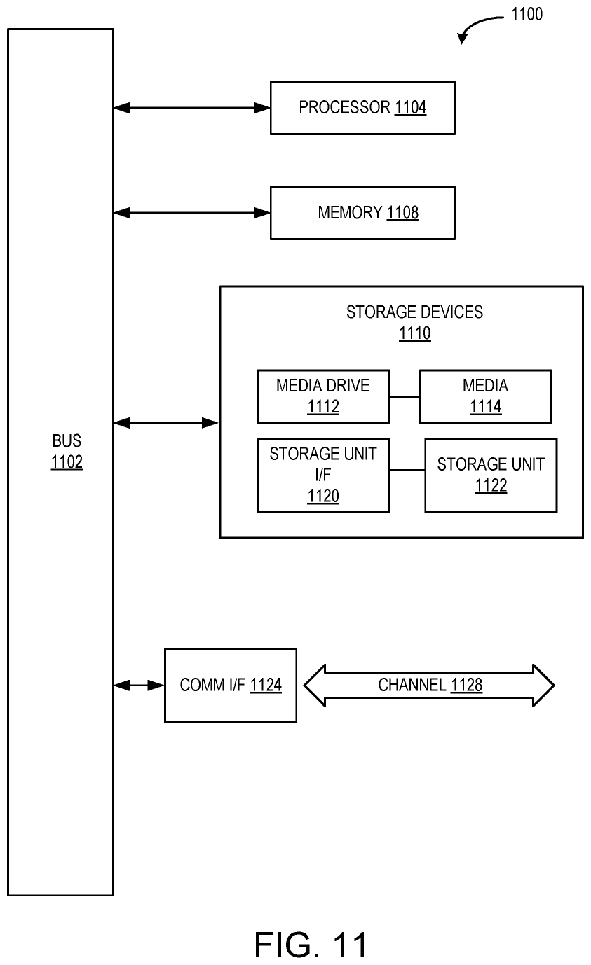

Incident management system 320 comprises server 321 and database 322, each of which are resident on a network. Server 321 may be an edge server, a cloud server, or a combination of the foregoing. For example, server 321 may be an edge server implemented as a processor-based computing device installed in an at an edge of a network and/or some other processor-based infrastructure component of a roadway. While a cloud server may be one or more cloud-based instances of processor-based computing device residents on the network. Server 321 in this example includes a communication circuit interface and incident management system. Server 321 may be implemented, for example, as a computing component 1100 of FIG. 11.

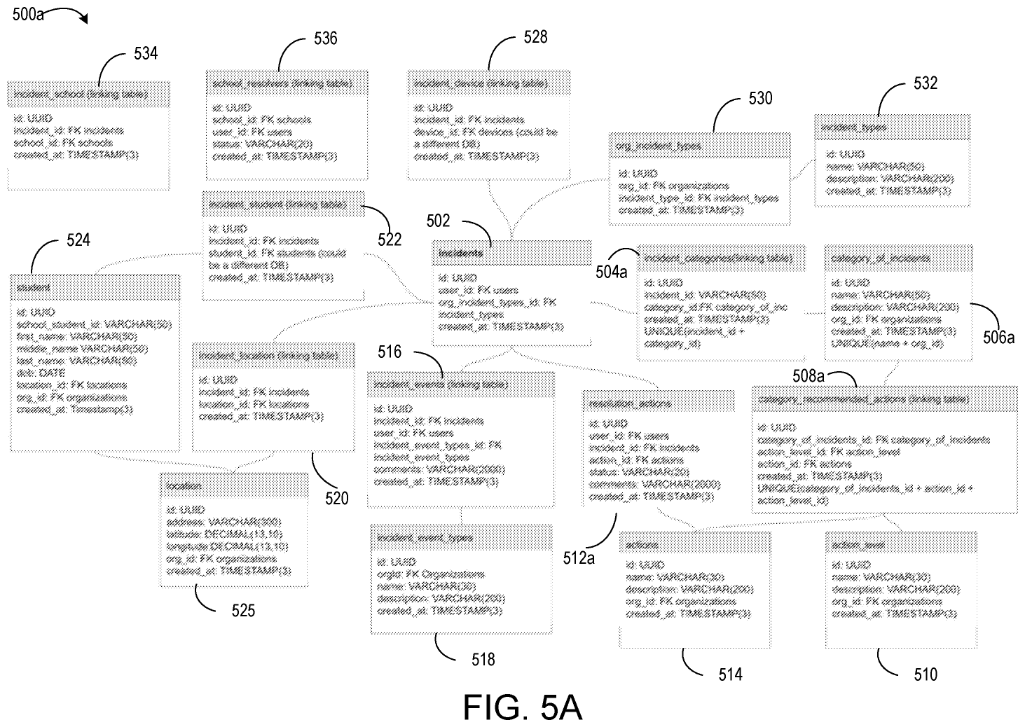

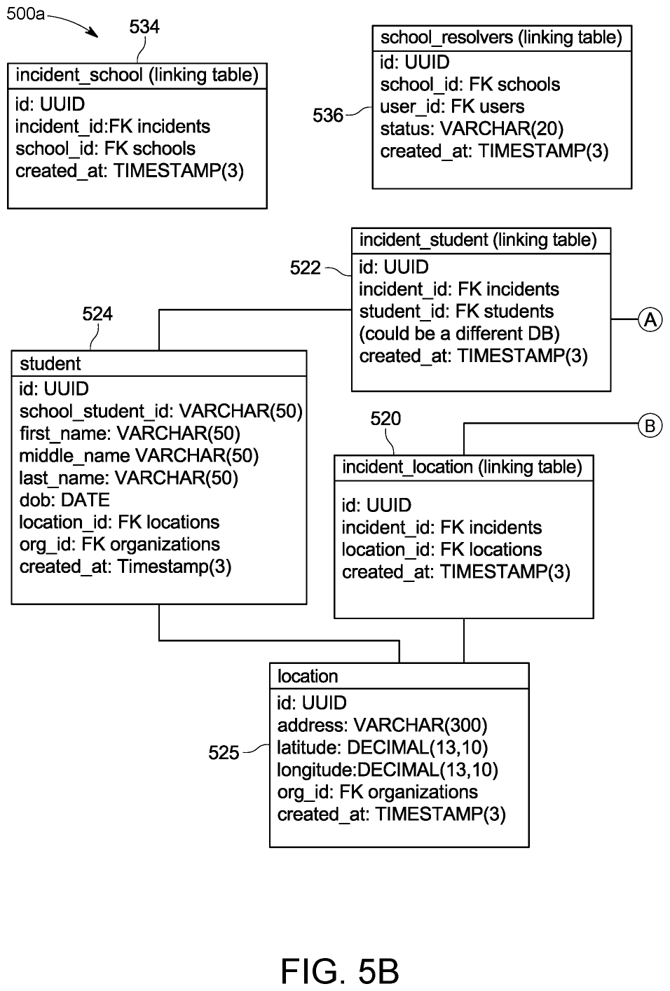

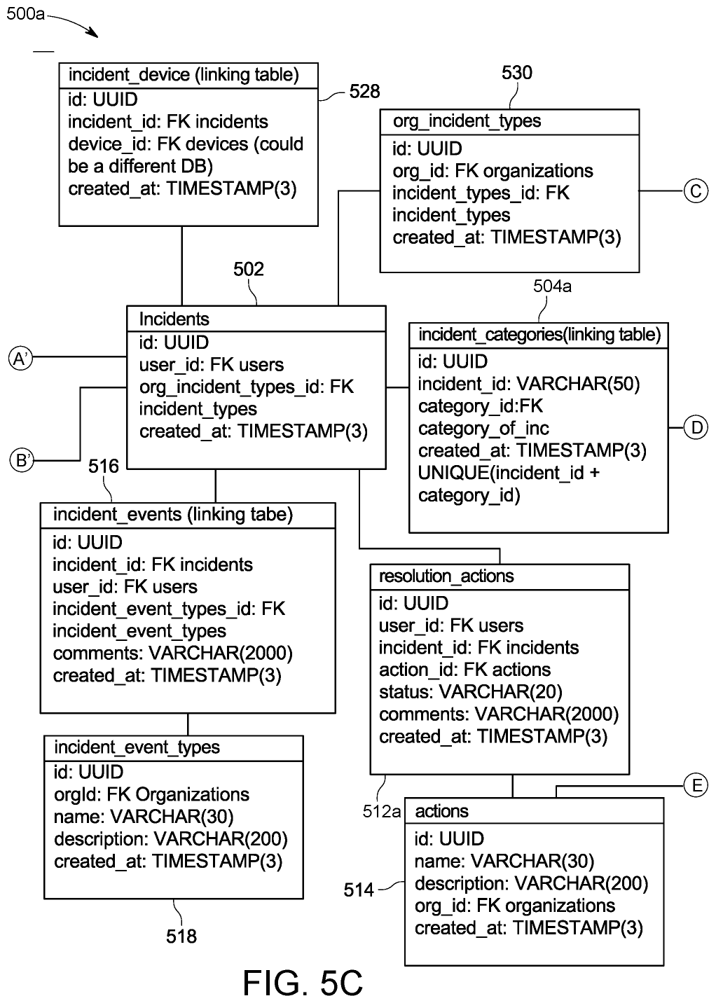

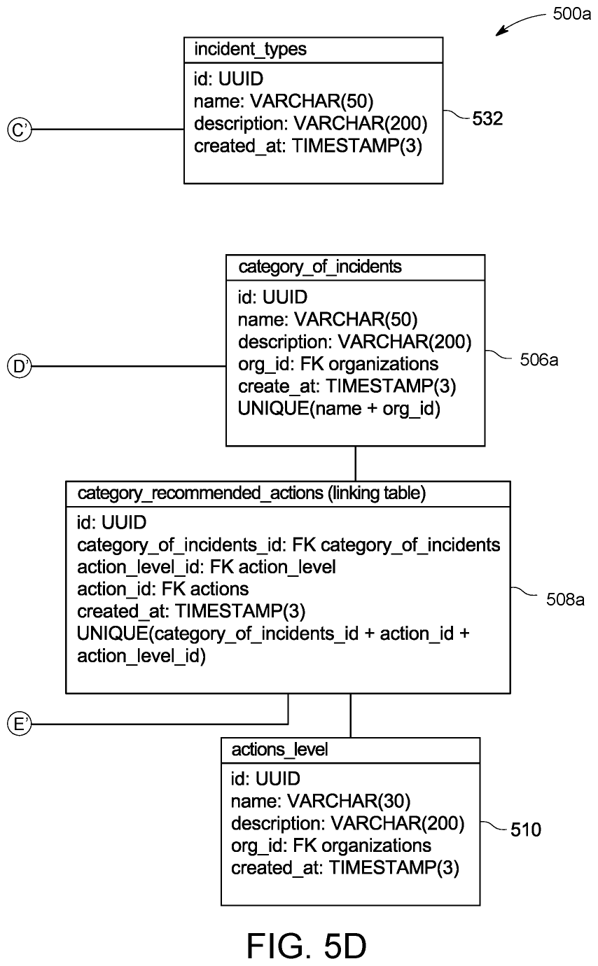

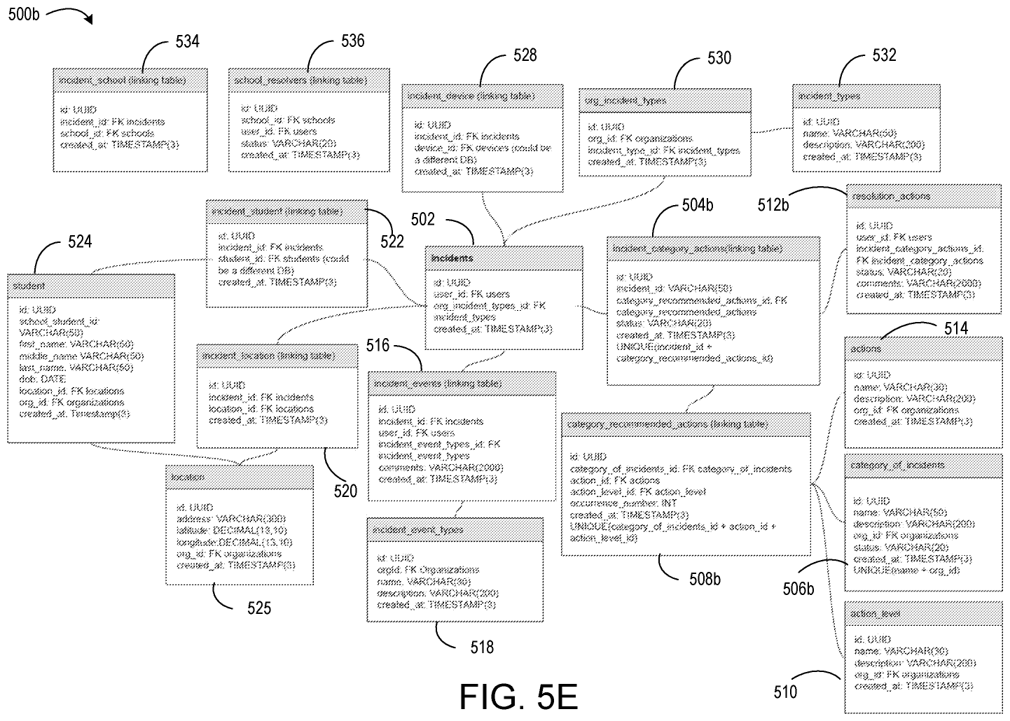

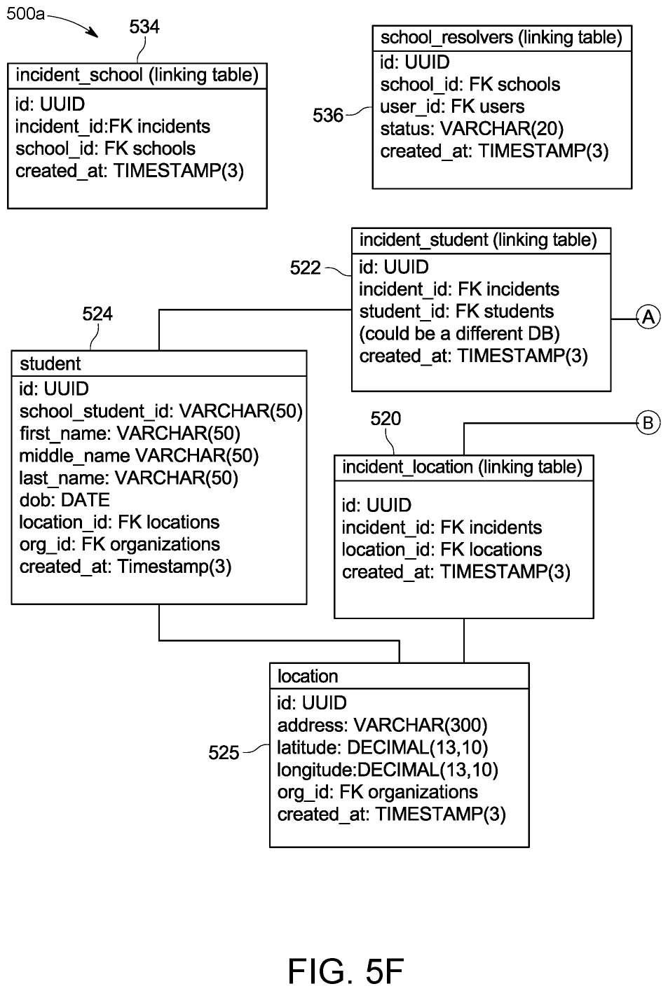

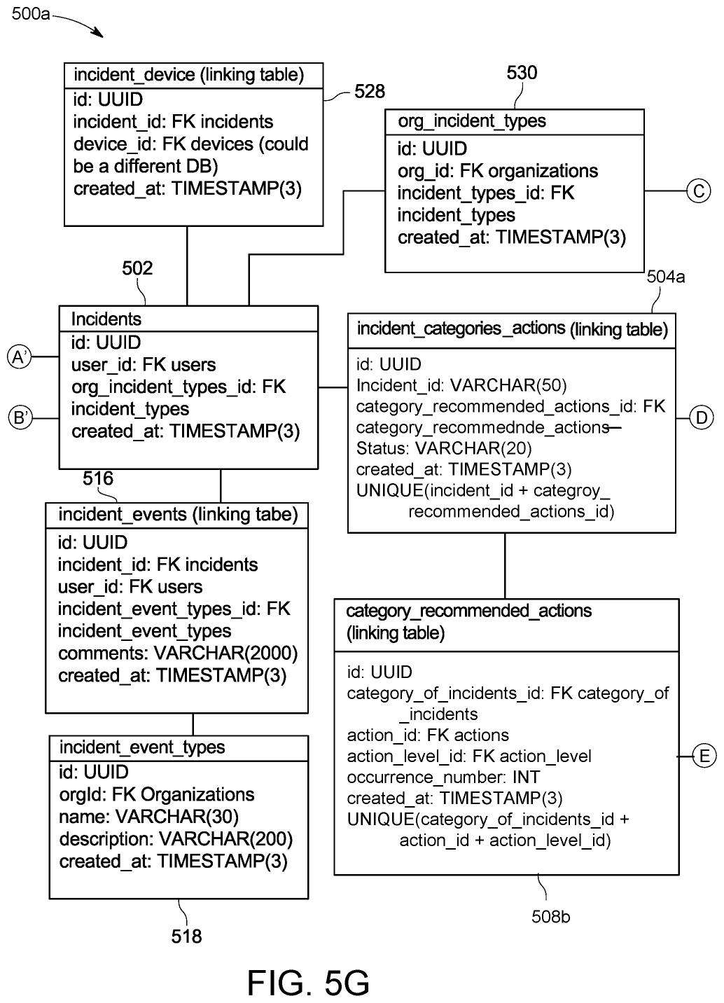

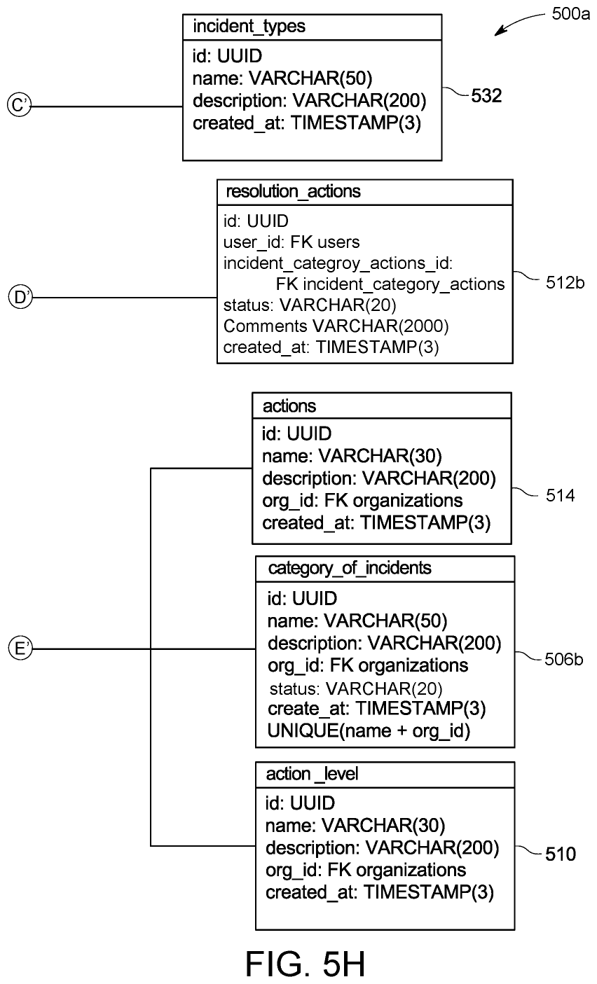

The server 321 may store information and data in cloud-based database 322. The database 322 may include one or more various forms of memory or data storage (e.g., flash, RAM, etc.) that may be used to store suitable information, such as, one or more of the following elements: passenger identifiers (IDs); passenger addresses; passenger contact information; images of passengers; route and schedule information for vehicle 310, such as stop locations, times, and passengers scheduled for each stops; passenger history, such as candidate incidents information in which a passenger has been tagged, resolved incidents and information on the resolution, pending or unreview incidents, and the like; seat assignment information comprising associating passenger IDs with a seat on vehicle 310 (e.g., a specific seat 114 assigned to each passenger), along with other data as needed. Database 322 may also store data tales described below in connection with FIGS. 5A/5B and 6.

The incident management system hosted on server 321 comprises code and routines that, when executed by a processor cause the processor to control various aspects of incident management system using information received from vehicle 310. The incident management system comprises a backend application 324 and a task scheduler application 323, each of which communicatively interface with the vehicle 310 via an application protocol interface (API) gateway. For example, task scheduler application 323 interfaces with incident detection client 205 included in vehicle 310 via a communication circuit (e.g., communication circuit 201) using APIs installed therein. The task scheduler application 323 assigns and schedules tasks to be performed by the incident detection circuit 210 of vehicle 310 and to be performed by server 321. Backend application 324 also interfaces with incident detection client 205 included in vehicle 310 via a communication circuit (e.g., communication circuit 201) using APIs installed therein. The backend application 324 receives information shared by the vehicle 310 and registers the information in database 322. In some embodiments, task scheduler application 323 and backend application 324 may be comprised in an incident management backend system 327a.

The backend application 324 may also forward or transmit information to an incident management frontend system 329a via the API gateway. The incident management frontend system 329a comprises one or more user-interface applications that can be accessed through an end-user device, such as a smartphone 330a, a laptop 330b, a workstation, a computer, a tablet, or any other computing processing system or component capable of receiving and presenting such information/data. In some examples, one or more end-user devices may be located on premise of a building 330n, which may be a school or office building. In some examples, the user-interface applications may be executed by a web browser executing on an end-user device. In another example, the user-interface applications may a mobile application designed for execution on a smartphone, tablet, or the like. In the illustrative example of FIG. 3A, the incident management frontend system 329a comprises a resolver webapp interface 325 for accessing incident management system 320 (e.g., school district personnel who may be assigned to resolve incidents), a webapp interface 326 for accessing incident management system 320 to create incident reports (e.g., bus drivers), and a user webapp interface 328 for users of the system (e.g., passengers, parents, etc.).

FIG. 3B is another example network architecture 300b of an incident detection, reporting, and resolution system in accordance with various embodiments disclosed herein. The architecture 300b is substantially similar to architecture 300a of FIG. 3A described above, which includes an incident management system 320 hosted on server 321, one or more vehicles 310, and a plurality of end-users device 330. The description provided in connection with FIG. 3A applies equally to like numbered components of architecture 300b.

Incident management system 320 includes backend system 327b and incident management frontend system 329b. Backend system 327b provides similar functionality as incident management backend system 327a of network architecture 300a, but is stacked into a single interface for providing the functionality. Architecture 300b also includes a cloud messaging service (such as Firebase Cloud Messaging services offered by Google and the like) that provides messaging interfaces and protocols for interfacing with end-user devices 330. Incident management frontend system 329b provides similar functionality as incident management frontend system 329b, such as providing a webapp interface over which one or more user-interface applications can be accessed through an end-user device. In the example of architecture 300b, incident management frontend system 329a provides a webapp interface that services a plurality of web-portals, such as, but not limited to, an incident management portal (e.g., similar to webapp interface 326, webapp interfaces 325, or a combination thereof), a driver portal (e.g., similar to webapp interface 328), a parent portal (e.g., similar to webapp interfaces 328), and a routing portal for creating, editing, and managing bus routes. While specific example portals are provided herein, the present disclosure is not intended to be limited to the example portals. Other portals may be included as part of incident management frontend system 329b.

Reference throughout the present disclosure to architecture 300 will be understood to refer to network architecture 300a, architecture 300b, or a combination thereof. Similarly, reference to incident management backend system 327 will be understood to refer to incident management backend system 327a, backend system 327b, or a combination thereof. Additionally, reference to incident management frontend system 329 will be understood to refer to incident management frontend system 329a, incident management frontend system 329b, or a combination thereof.

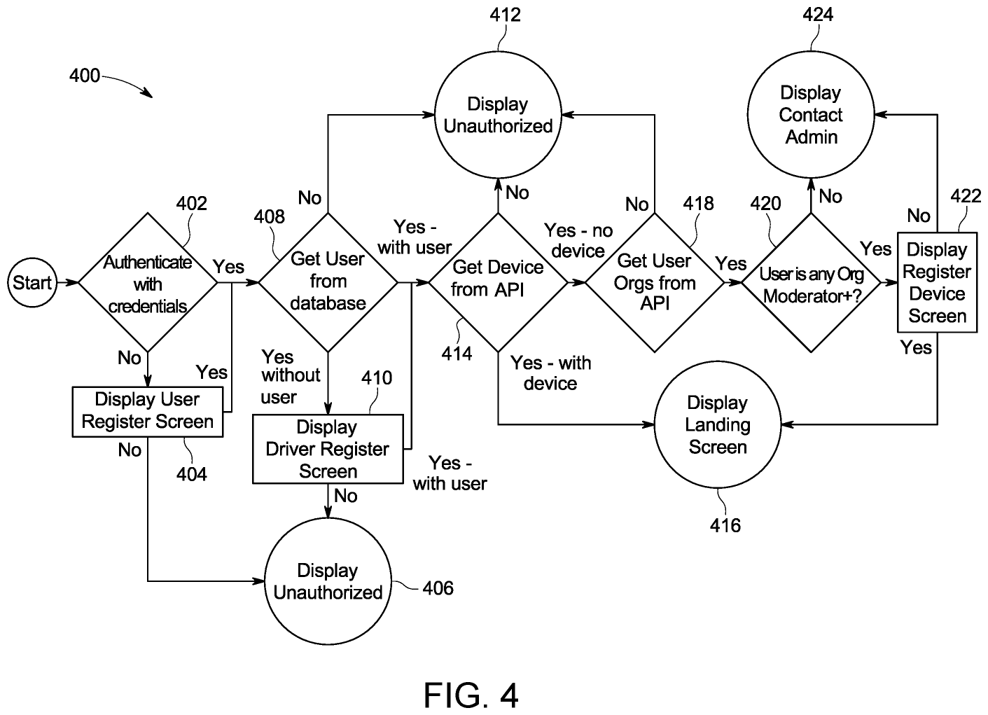

FIG. 4 is a flow chart illustrating example operations for authenticating end-user devices on the incident detection and management system of FIGS. 3A and/or FIG. 3B in accordance with various embodiments disclosed herein. FIG. 4 illustrates a process 400 that may be implemented as instructions, for example, stored on server 321, that when executed by one or more processors perform, or cause to be performed, the operations of process 400.

Process 400 starts at block 402 when a user attempts to log onto the system through an end-user device (e.g., one of end-user devices 330) by entering user credentials (e.g., a username and password/pin or biometric authentication), which are verified against stored registered users. If block 402 determines that the end-user device is not verified (e.g., password/pin/biometric and/or username do not match or are not stored in database 322), the process proceeds to block 404. For example, block 402 may return a HyperText Transfer Protocol (HTTP) 401 error code that indicates that the end-user device request has not been completed because it lacks valid authentication credentials for the requested resource. Block 404 attempts to display a user registration screen. If the user does not register or is unsuccessfully, process 400 proceeds to block 406, in which case an error is displayed on the end-user device indicating that the user is not authorized for access. For example, another HTTP 401 error code may be issued.

If the user is able to register at block 404 or the end-user device is authenticated at block 402, process 400 proceeds to block 408. For example, block 404 may return an HTTP 201 response code (Created success status response code) that indicates the request has succeeded and has led to the creation of a resource. Block 402 may generate a HTTP 200 response code (e.g., OK success status response code) that indicates that the request has succeeded. At block 408, based on an entered username, process 400 attempts to retrieve (e.g., using a GET command) the user from the database 322 via the API of the backend application 324. If the user, according to the username, is not located in the database 322, the process proceed to block 412 and displays not authorized for access on the end-user device. For example, block 408 may generate one or more of a HTTP 403 response code indicating that the end-user device is forbidden from accessing the system (e.g., the server 321 understands the request, but it can't fulfill the request because the end-user device isn't authorized to access the API of the backend system 327) and an HTTP 401 response code.

If block 408 determines that the username is located in the database but is unable to retrieve the user, process 400 proceeds to block 410, where a screen is displayed for the user to register for access on the system. For example, block 408 may generate a HTTP 200 response code without user (e.g., the response does not include a user object) and proceed to block 410. If the user is unable to register, process 400 proceeds to block 406. For example, block 410 may generate one or more of an HTTP 401 and an HTTP 403 response code. Otherwise, once the user registers, the process 400 proceeds to block 414 (e.g., in the case that the response includes a user object). For example, block 410 generates a HTTP 201 response code with user. Similarly, if a determination as block 408 is that the user is registered, the process proceeds to block 414 (e.g., block 408 generates a HTTP 201 response code with user).

At block 414, process 400 attempts to confirm the end-user device itself is authorized for access to the system. For example, an identifier of the end-user device (e.g., MAC address, IP address, or the like) can be obtained from the end-user device and checked against an approved list of device identifiers. If the obtained identifier matches one on the approved list, the block 414 proceeds to block 416, where a landing screen is displayed on the end user device. For example, the device may be issued by the organization and assigned to a bus route. In this case, the device may be pre-approved and its identifier stored on the approved list. Thus, the end-user device has been authenticated for access to the system via a webapp that displays the landing screen. In an example block 414 generates an HTTP 200 response code with device, thereby proceeding to block 416.

If block 414 determines that the end-user device is located in the database but is unable to confirm the identifier, process 400 proceeds to block 418, where process 400 checks if an organization associated with the end-user is stored in the database 322. The user may be asked to enter identifying information for the organization at block 418 or during an earlier step. If the organization is not stored in the database 322, process 400 proceeds to block 412. In this case, for example, block 416 may generate a HTTP 401 and/or 403 response code. Otherwise, if the organization is located in the system (e.g., database 322), the process proceeds to block 420, where process 400 checks if the user is included as an organization moderator. For example, if the user is assigned a role, as described below, as a moderator for the organization. If block 420 is yes, process 400 proceeds to block 422, where a screen is displayed to register the end-user device with the system, in which case the user is permitted to register the end-user device for the organization where they are assigned the moderator role. Once registered, the process proceeds to block 416. If, on the other hand, the user does not register the end user device at block 422 or the user is not an organization moderator (block 420), the process proceeds to block 424 and instructs the user to contact an administrator. In the case of block 422, one or more of HTTP 403 and 401 response codes may be generated.

Data access and management according to embodiments disclosed herein may be applied using an organizational-based model. For example, an end-user may create and manipulate data of a particular organization if the end-user is assigned to that organization. This allows for data segregation across various interface domains and sharing of data with other users in the system, such as other organization members or Market Place associations, as described below. Data linking tables may be created and stored (e.g., in database 322) to facilitate the data access and management according to organization.

FIG. 5A is a block diagram of an example incident data model 500a in accordance with embodiments disclosed herein. FIGS. 5B-5D are zoomed in views of the data tables illustrated in FIG. 5A. Incident data model 500a comprises a plurality of linking tables 502-536, each comprising data fields that define for storing data defining an incident according to embodiments disclosed herein. Data fields may be linked to other data tables for calling a linked table. For example, as shown in FIG. 5A, each table 502-534 is tagged with a unique unit ID (e.g., UUID), which may be used by another table to call a tagged table using the UUID. Each table 502-534 also includes a timestamp of when the data of a respective table was generated or last updated. The linking tables and data included therein may be stored, for example, in database 322 of FIG. 3A or 3B. Certain data fields may be populated using information shared with the incident management backend system 327 from the vehicle 310 and/or end-user devices 330.

Incident table 502 comprises data related for accessing a particular candidate incident. Incident table 502 includes user ID of a user (or device) that generated the data and organization incident type identifier that references organization incident type table 530. Incident table 502 is linked to incident categories table 504a, which is associated with the incident table 502 via an incident ID. In this example, the incident ID may be the UUID for incident table 502. Incident categories table 504a includes an incident category ID that identifies a category of the incident. Incident table 502 is also linked to incident student table 522, which is also associated with incident table 502 via the incident ID (e.g., UUID of incident table 502). Incident student table 522 also includes a listing of one or more student IDs that lists students suspected to be involved in the incident identified by incident table 502. For example, suspected participants identified as described herein may be listed in incident student table 522. Further, incident table 502 is linked to incident location table 520, which can be linked to incident table 502 via the incident ID (e.g., UUID of incident table 502). Incident location table 520 also includes a location ID of a location of the incident identified by incident table 502. For example, the location ID may include a location provided as an area within a school bus (e.g., areas 118 in vehicle 100) populated based on identifying one or more passenger sensors 116 and/or door sensor 120 that detected conditions resulting in the incident identified in incident table 502 Additionally, incident table 502 is linked to an incident device table 528, an organization incident type table 530, a resolution actions table 512a, and an incident events table 516, each of which are associated with incident table 502 via the incident ID.

Incident device table 528 provides one or more device IDs of devices involved in detecting sharing the incident of incident table 502 and/or sharing data pertaining to the incident. For example, device ID may identify a school bus by a bus number, VIN number or other identifying information. In another example, the device ID may list one or more passenger sensors 116 and/or door sensor 120 that detected conditions that resulted in a candidate incident. As another example, the device ID may identify an end-user device that provided data used to populate another data table of incident data model 500a.

Organization incident type table 530 provides an organization ID and an incident type ID. Organization incident type table 530 can be called by incident table 502 using the organization incident type ID (e.g., UUID of organization incident type table 530). Organization incident type table 530 is linked to an incident type table 532, which includes a name and description of incident types. The name and description can be used to populate a screen on an end-user device. Each organization (e.g., organization table 604) can create a reference to organization incident type table 530 that the organization wants to include, such as, but not limited to, “Unsafe Behavior”, “Bullying”, etc. Incident type table 532 provides incident types defined in the system (e.g., incident management system 320). The organization creates an individual reference to each system defined incident type from organization incident type table 530 using an entry in organization incident type table 530 (e.g., incident type identifier).

Incident categories table 504a is linked to a category of incidents table 506a, which is associated with incident categories table 504a via the incident ID (referred to as name in Incidents table 506a). Incidents table 506a includes a name and a description of the category associated with the incident of incident table 502 and an organization ID for associating the category of incidents with the organization. Through incident categories table 504a and incidents table 506a, organizations may define different categories where applicable. The name and description of can be used to populate a screen on an end-user device.

Incidents table 506a is linked to a category recommendation action table 508a, which is associated with incidents table 506a via a category of incident ID. Category recommendation action table 508a includes an action ID, which defines a recommendation action for resolving the incident identified by incident table 502. For example, the category of incidents ID can call an action ID based on the category identified. Category recommendation action table 508a also includes an action level ID, which links category recommendation action table 508a to an action level table 510. That is, an action level ID in category recommendation action table 508a can call a particular action level table identified by the action level ID. Action level table 510 includes a name of the action level and a description, which can be used to populate a recommendation for resolving the incident. Category recommendation action table 508a can also be linked to actions table 514, which can be called using the action ID (e.g., UUID of actions table 514). Actions table 514 includes a name of the action identified in category recommendation action table 508a and a description. In this way, the category recommendation action table 508a can call an action and actin level as a recommendation of actions, which may be displayed on end-user devices.

Resolution actions table 512a is linked to incident table 502, as noted above, via the UUID of incident table 502. Resolution actions table 512a includes an action ID that identifies an action to be or has been taken for resolving the incident, a status description providing a current status of implementing the action (e.g., pending, under review, resolved, etc.), and comments that may be entered by users. The user ID field identifies a user who has been assigned to resolving the incident identified by incident table 502. Resolution actions table 512a is linked to actions table 514 through the action ID. In this way, the resolution actions table 512a may call actions table 514 via the action ID, which identifies one or more actions that may be used in resolving the incident.

Incident events table 516 is linked to incident table 502, as noted above, via an incident ID (e.g., populated with the UUID of incident table 502) included in incident events table 516. Incident events table 516 comprises an incident event type ID, which can be used to call incident event types table 518 and a user ID identifying one or more users who shared data used for populating the fields of incident events table 516. As an example, an incident event type may be a state transition. For example, when an event is created, the incident event type may be “CREATED”, when it is updated, resolved, and acknowledged, the incident event type is updated accordingly. The life cycle of an incident may thus be tracked using incident event types table 518. Incident event types table 518 includes the organization ID, a name of a particular incident event type called, and a description.

As described above, incident location table 520 is linked to incident table 502. Incident location table 520 can call a location from location table 525 using the location ID. For example, an address, latitude, and/or longitude can be retrieved for a location ID of the incident location table 520. In an example, the location table 525 may include a location provided as an area within a school bus (e.g., areas 118 in vehicle 100) that is populated based on identifying one or more passenger sensors 116 and/or door sensor 120 that detected conditions resulting in the incident of incident table 502.

As described above, incident student table 522 is linked to incident table 502. Incident student table 522 can call identifying information of a suspected passenger participant using student table 524 via a student ID included in incident student table 522. For example, information pertaining to each student participant identified in incident student table 522 can be retrieved by calling a corresponding student table 524. For example, student table 524 may include first, middle, and last name of the student, date of birth, location identifier, and an organization identifier. Location ID may identify a home address or a current location of the student. Student table 524 may call location table 525 using the location identifier.

Incident School linking table 534 can be called by incident table 502 using the incident ID (e.g., UUID of incident table 502). Incident School linking table 534 provides a school ID associated with the incident, which can be used to call a resolvers table 536. Resolvers table 536 includes user IDs of persons who may participate in resolving the incident of incident table 502 according to category recommendation action table 508a and/or resolution actions table 512a. Resolvers table 536 also includes a status field for a current status (e.g., pending, under review, resolved, etc.) of the resolution.

FIG. 5E is a block diagram of another example incident data model 500b in accordance with embodiments disclosed herein. FIGS. 5F-5H are zoomed in views of the data tables illustrated in FIG. 5E. Incident data model 500b is similar to incident data model 500a, except that some of the tables are linked in an alternative configuration and comprises different data. For example, incident categories table 504a is replaced with incident category actions linking table 504b, which references to resolution actions table 51b as shown in FIG. 5B. Table 504b also links to category recommended actions linking table 508b, which refers to actions table 514, incidents table 506a, and action level table 510. Accordingly, incident data model 500b illustrates another example implementation for an incident data model that can be utilized in the embodiments disclosed herein. Thus, reference throughout the present disclosure to incident data model 500 will be understood to refer to incident data model 500a, incident data model 500b, or a combination thereof.

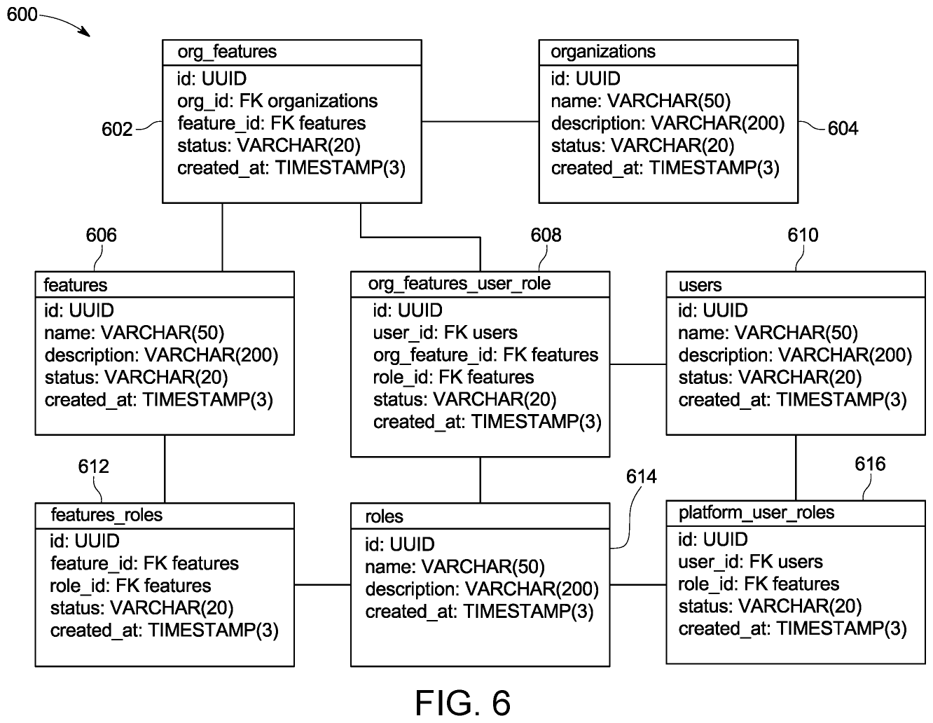

FIG. 6 is a block diagram of an example end-user roles data model 600 in accordance with embodiments disclosed herein. User roles data model 600 comprises a plurality of linking tables 602-616 that comprise data fields defining used roles within an organization stored according to embodiments disclosed herein. The linking tables and data included therein may be stored, for example, in database 322 of FIG. 3A or 3B. Certain data fields may be populated based on information shared with the incident management backend system 327 from the vehicle 310 and/or end-user devices 330. As shown in FIG. 6, each table 602-616 is tagged with an ID (e.g., UUID) for use in calling the table by a linked table and a time stamp of when the data of a respective table was generated.

Organization features table 602 comprises an organization ID, features ID and a status indicator. The organization ID can be used to call organization table 604, which provides a name of the organization, a description of the organization, and a status. Example status includes, but are not limited to, ACKNOWLEDGED, ACCEPTED, ACTIVE, ASSIGNED_ACTIVE, ASSIGNED_INACTIVE, BLOCKED, CANCELLED, COMPLETE, CONDITIONAL, ENTERED_GEOFENCE, EXITED_GEOFENCE, INACTIVE, INVITED, READ, REJECTED, ROUTE_COMPLETED, ROUTE_STARTED, SELECTED_ACTIVE, SELECTED_INACTIVE, and NEW, among others. An organization may have the following statuses ACTIVE, INACTIVE, and BLOCKED, among others.

The feature ID can call features table 606 for the identified feature. Features table 606 includes a name of the feature and a description, along with a status. Features may refer to a functionally that is active for the organization, which may be indicated by the status (e.g., active or inactive). Example features include, but are not limited to, ORG_FEATURE, which may be used to track user roles, STUDENT_INCIDENT_FEATURE (e.g., incident detection, report creation and resolution according to the embodiments disclosed herein), a ROUTING_FEATURE, and a FIND_MY_BUS_FEATURE, among others.

Table 602 is linked to organization feature user role table 608 through the organization feature ID (e.g., UUID for table 602). Organization feature user role table 608 includes user IDs which can be used to call users table 610 for each user identified, role IDs which can be used to call roles table 614 for each role identified, and a status indicator. Each users table 610 includes a name and a description of a respective user, along with a status of the user within the organization. Each role table 614 includes a name and a description of a respective role. The users table 610 and roles table 614 can be used to populate a platform user roles table 616, which includes a user ID and role ID, along with the status of the user.

A feature roles table 612 can be populated using a feature ID from features table 606 and a role ID from roles table 614. Feature roles table 612 can also include a status indicator.

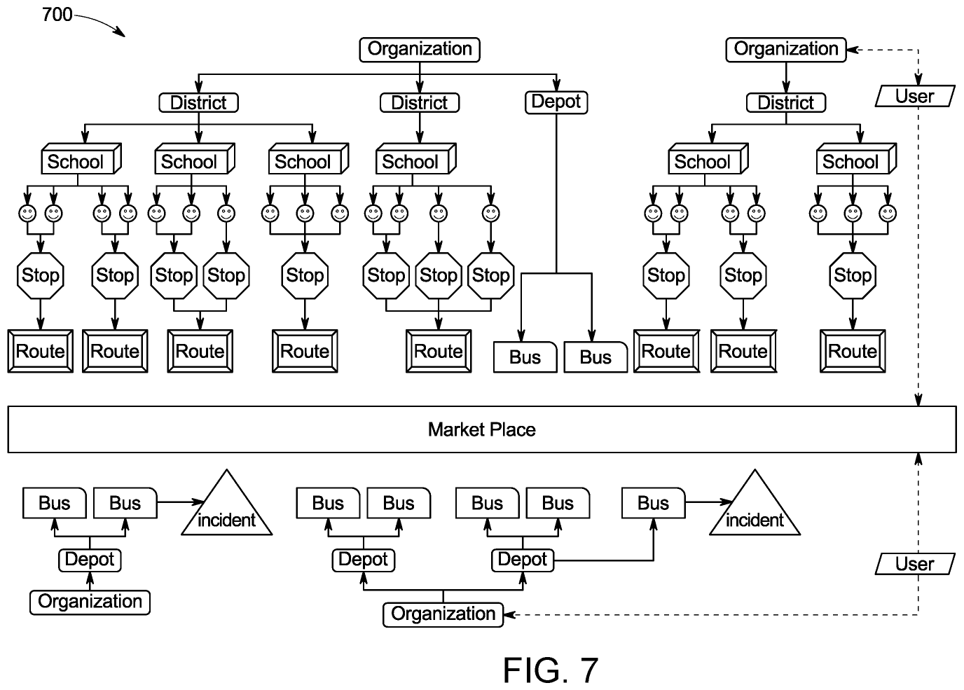

FIG. 7 illustrates a schematic hierarchical tree diagram of a school bus service market place 700 in which embodiments of the disclosed technology can be implemented. As shown in FIG. 7, school bus service market place 700 comprises organizations at an upper level, and each organization branches into one or more districts and/or depots. Each district branches into one or more schools, which encompass a plurality of students. For each organization, student tables 524 can be populated using identifying information of each student. Each student can be associated with a bus stop, such that each stop corresponds to one or more students. Each stop is then assigned to a route served by a bus (e.g., vehicle 100). The depot servers to coordinate buses for a given organization, and assign a bus to a route of stops.

Each organization consists of numerous employees or users. Users in an Organization may have a role based access to functionality of the incident detect, resolution, and resolving system. Example organizational roles (e.g., roles table 614) includes, but are not limited to, ORG_ROUTE role, ORG_BUS role, ORG_USER role, ORG_MODERATOR role, ORG_ADMIN role, and so on.

The ORG_ROUTE role is a role that grants view access to data needed for a school to see a bus assigned to a route and historical data about that bus on the route. This role may be restricted to access to information pertaining to the bus/depot/organization for that route for the time period the bus was assigned to the route. Example tables in which this data is stored include, but are not limited to, bus route assignment events tables; bus ID (e.g., incident device table 528); route ID; event type (e.g., incident event types table 518), which may be assigned to an incident or unassigned; created by, which may be an identifier of a user actioning event (e.g., user ID in incident table 502); created at timestamps; device event (e.g., data sent by a device, such as location reporting, incident creation, driver communications, route events, and so on can be categorized as a device event), which may include an event type and device registration status; bus incident events (e.g., incident table 502) defining candidate incidents occurring on a school bus; and route events. Bus incident events may include incident data model 500a, such as an incident ID; bus or device ID (e.g., incident device table 528); event type (e.g., incident events table 516) including operator SUBMITTED event, SCHOOL REVIEWED event, SCHOOL ACTIONED event, and operator ACKNOWLEDGED event; created by (e.g., ID of user actioning event, which can be included in incident table 502); and created at time stamps. Route events may include data such as, but not limited to, a route ID; event type (e.g., incident events table 516) such as ROUTE STARTED, ROUTE COMPLETED, ROUTE CREATED, ROUTE UPDATED, ROUTE DEACTIVATED, ROUTE DELETED; created by information (e.g., ID of user actioning the event); and created at timestamps.

The ORG_BUS role is a role that grants view access to data needed for servicing a route, such as student, stop, and route info. The organization owning or exercising control over the bus may have access to this information for the route as it appeared during a period the bus serviced the route.

The ORG_USER role is a role that grants view access to districts, schools, depots, bus, bus operators, riders, depots, bus stops, and routes.

The ORG_MODERATOR role is a role that grants write access (e.g., editing access) of depots, bus, bus operators, rider, depot, bus stops, and routes. This role includes all rights attributed to the ORG_USER role.

The ORG_ADMIN role is a role that grants access to update users (e.g., add/remove) on an organization. This role includes all rights attributed to the ORG_MODERATOR role.

Users of the disclosed technology can be members of multiple organizations and have different roles for each organization. When interacting with the embodiments disclosed herein, a user may be required to select an organization they wish to access, while data to other organizations is then restricted.

According to various implementations, when a bus is assigned to a route by a depot, users in the organization that owns or exercises control over the bus will be granted the role “ORG_BUS” role. This authorizes the users to read (e.g., view) endpoints and stops, student, and school data related to routes assigned to the bus. The “org_bus” endpoints and displayed view may be tagged with a route_id, which will be used to return/display information pertaining to that route during the time periods that the bus was assigned to the route. Thus, the bus organization can maintain historical data access, while restraining data to a “need to know” basis.

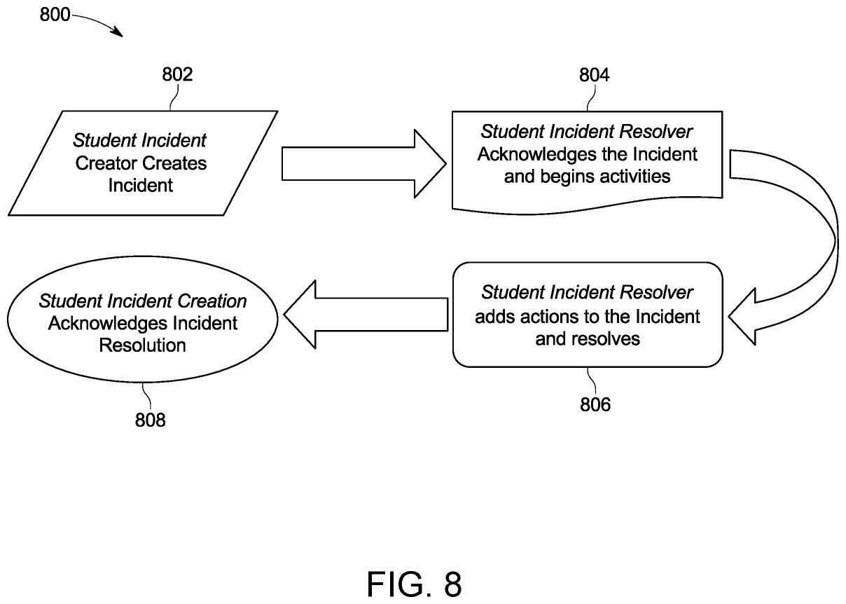

FIG. 8 is a process flow illustrating example operations for generating a candidate incident report in accordance with various embodiments disclosed herein. FIG. 8 illustrates a process 800 that may be implemented as instructions, for example, stored on server 321, that when executed by one or more processors perform, or cause to be performed, the operations of process 800.

Incidents in accordance with the embodiments disclosed herein may have the following actors: an Incident Creator, an Incident Resolver, and an Incident Administrator. An Incident Administrator may assign Incident Resolvers, define incident types, and, in some examples, provide recommended actions for incident types according to set categories, such as age level of participants, location of incident, number of repeat occurrences of incident, overall frequency of occurrence by organization, etc. The Incident Administrator, in some examples, may by a School District level user, who may have a detailed view of the incidents occurring in their districts and can aggregate data for analysis. Using the data, the Incident Administrator can make assumptions about action effectiveness, quickly identify hot-spot issues or bus routes, and enact policy to reduce future incidents. According to various embodiments, one or more of the above actions can be performed by an Incident Administrator via a portal on a browser, such as webapp interfaces 325, 326, and/or 328. In another embodiments, one or more of the above actions can be performed by the incident detection and management system configured by the Incident Administrator. For example, an Incident Administrator may define incident types in the system and associate recommended actions for each incident type according to the categories.

Once the incident types are defined and the recommended actions associated therewith, process 800 can be initiated at block 802, during which a Student Incident Creator creates an incident report. In one example, the Incident Creator may be an operator of the school bus (e.g., vehicle 100) or aide. In this example, the Incident Creator may use an end-user device to enter data for the creation of an incident report, such as a description of the incident, incident category, location, and participants involved. The incident report may then be uploaded to the incident management system (e.g., server 321) for storing and processing. The Incident Creator (once authenticated via process 400) can also access and view data of historical incidents and/or access identifying information of the involved students through the incident management system.

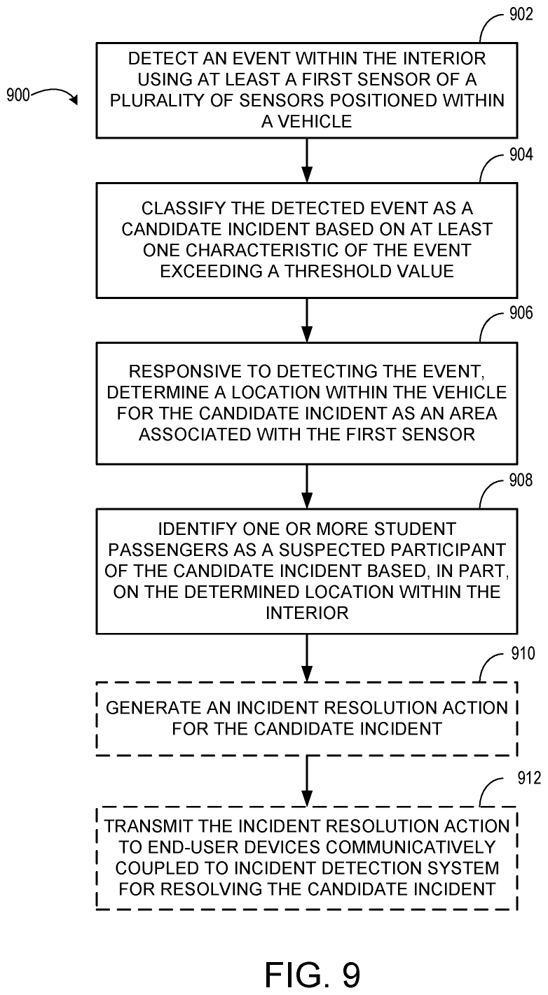

In another example, the school bus may comprise an incident detection circuit 210 that acts as the Incident Creator. For example, the incident detection circuit 210 may detect a candidate incident and identify one or more student participants, as described in greater detail below in connection with FIG. 9. In one case, the incident detection circuit 210 may then generate an incident report by populating fields of the incident report with data derived from the candidate incident and student participants. For example, incident detection circuit 210 may recognize an incident type and incident category from the detected condition. Incident detection circuit 210 may identify participants based on locations with the school bus, names spoken and detected by sensors, accessing a seat assignment and correlating the seat assignment with the detection location to identify students assigned to that location, and combinations thereof. The incident detection circuit 210 can then populate an appropriate data field with the incident type, category, and participants. Furthermore, incident detection circuit 210 may store organization and school IDs that can populate data fields, along with inserting a bus ID or an operator ID as a user ID. The incident report created by the incident detection circuit 210 may be uploaded to the incident management system for storage according to incident data model 500 (e.g., generating incident table 502 and linking appropriate tables. In another example, incident detection circuit 210 may upload the data to the incident management system, which can generate the incident report by populating appropriate data fields. In some examples, a bus operator or aide may review the data generated by incident detection circuit 210 and acknowledging the incident report, which triggers uploading to the incident management system. In another example, the data can be automatically uploaded or uploaded upon reaching a set destination (e.g., a school having wireless access points for establishing connections between bus and cloud servers).

In either case, once the incident report is generated, the report can be used to address student behavior issues. At blocks 804 and 806, an Incident Resolver can acknowledge the incident, begin resolution activities, and generate an incident resolution action plan for the incident report. In some examples, the Incident Resolver may be an end-user assigned by the Incident Administrator for resolving the incident. The end-user may be identified by resolvers table 536. In this case, the Incident Resolver may receive a notification of an incident report, which the Incident Resolver acknowledges and beings resolution activities. In this case, the Incident Resolver may access the incident management system and access the incident report. The incident management system may link the incident report to recommendation actions (e.g., incidents table 506 and action level table 510) based on the incident type and categories of the incident. Thus, when the Incident Resolver accesses the incident report, the incident management system can generate recommended actions for resolving the incident, which can be displayed to the Incident Resolver on an end-user device as an incident resolution action plan. The Incident Resolver may execute the recommended actions or take other actions deemed appropriate by the Incident Resolver. In either case, the Incident Resolver enters the actions taken, comments, and a status into the incident management system (e.g., resolution actions table 512a).

In another example, the incident management system may act as the Incident Resolver. In this case, the incident management system issues an acknowledging response and processes the incident report. For example, the incident management system uses the incident type and categories include in the incident report to retrieve recommended actions for resolving the incident. Using the recommended actions, the incident management system generates an incident resolution action plan. An end-user assigned to resolve the incident may then access the incident resolution action plan and proceed as outlined above. In some examples, the incident report may be updated to include the incident resolution action plan.

Once the incident is resolved, process 800 notifies the Incident Creator of the resolution and the Incident Creator can acknowledge the resolution (block 808). For example, notifications can be transmitted to an end-user review of a bus operator or aide so that the bus operator may track incidents and ensure that a resolution is obtained. In some embodiments, the notification is transmitted responsive to a status in resolution actions table 512a being set to resolved or complete. In this way, the Incident Resolver does not need to actively send a message to the Incident Creator notifying of the resolution.

In some embodiments, the incident management system may use the data entered by the Incident Resolver in resolving an incident to learn actions that can be associated with categories of incidents. For example, new recommendation actions can be derived from actions entered into resolution actions table 512a that resolved the incident. Actions that are successful in resolving an incident may be attributed higher weights, while actions recommended in category recommendation action table 508a that were not used or were unsuccessful may be attributed less weights. The incident management system may then generate a ranked list of recommended actions in the resolution action plan, where the higher ranking corresponds higher weights (e.g., more success in resolving an incident and lesser ranking correspond to lower weights.

FIG. 9 is a process flow illustrating example operations of incident detection in accordance with various embodiments disclosed herein. FIG. 9 illustrates a process 900 that may be implemented as instructions, for example, stored in memory, that when executed by one or more processors perform, or cause to be performed, the operations of process 900. The operations of process 900 may be executed, for example, by an incident detection circuit 210 of FIG. 2, incident management system 320 FIG. 3A or 3B, an end-user device 330 of FIG. 3A or 3B, or a combination thereof.

At block 902, an event within an interior of a vehicle (e.g., vehicle 100 or network architectures 300a/300b) can be detected. For example, as described above, a vehicle (such as a school bus) may comprise a plurality of sensors (e.g., passenger sensors 116 and/or door sensor 120) associated with designated areas in the interior of the vehicle (e.g., areas 118). In an example implementation, a first sensor (e.g., passenger sensors 116) may detect conditions occurring with an associated area, thereby detecting an event. The event comprises one or more characteristics based on the type of sensor used. For example, in the case of an audio sensor, the event may comprise such as amplitude, frequency, timber, envelope, velocity, and so on. In the case of a motion sensor, the characteristics may comprise velocity, acceleration, and direction in a Cartesian coordinate system. In the case of an image sensors, the characteristics may comprise image data, such as sequential image frames, which may be processed using object recognition techniques to derive motion and audio characteristics, along with facial recognition to identify participants included in the image data.

At block 904, the detected event can be classified as a candidate incident based on at least one characteristic exceeding a threshold value. The threshold value may be set in advance. For example, in the case of audio events, the threshold may be an amplitude value. If the amplitude of a detected audio event exceeds the threshold (e.g., indicative of fighting or arguments), the detected audio event may be classified as a candidate event. Similarly, high frequency audio events may be indicative of increased stress that may be classified as a candidate incident. Thus, the threshold value may be frequency value set in advance. In the case of motion sensors, an increase in total detected motion (e.g., aggregate amount of motion) may be indicative of a fighting, and the threshold value set as an aggregate motion value. As another example, increase acceleration of a body part of a passenger and/or an object may be indicative of fighting or thrown object, respectively. Thus, the threshold value may be an acceleration value set to recognize such conditions. In yet another example, a direction of movement relative to a passenger body may be indicative of fighting (e.g., punching or shoving motions) or objects thrown. In this case, the direction may be set as a threshold, for example, in combination with the velocity or acceleration thresholds. In the case of image sensors, the image data may be processed using object recognition techniques to extract motion characteristics and apply similar thresholds as discussed above.

At block 906, responsive to detecting the event, a location within the interior for the candidate incident can be determined as an area associated with the sensor that detected the event. For example, in the case of passenger sensors 116, the location may be determined as an area 118 associated with the passenger sensors 116. In an example implementation, a passenger sensors 116 may generate sensed signal 128, tagged with device ID of the passenger sensors 116, which is provided to incident detection circuit 210. Incident detection circuit 210 (or incident management system 320) may access a data table comprising device IDs of sensors 116 and locations within vehicle 100 (e.g., seats in an example implementation), and retrieve the associated location. In the case where the area 118 comprises a seat 114, the location may be a seat. In the case of door sensor 120, the location may be determined as the doorway or area outside of the vehicle adjacent to the doorway.

While the above examples describe the use of a first sensor, the embodiments disclosed herein are not so limited. In some implementations, a plurality of sensors may be utilized to detect events. For example, a first sensor at a first location may detect a first event and a second sensor at a second location may detect a second event. If the two locations are close in proximity to each other (e.g., adjacent seats in a row or column), the events may be combined into a single event and, thus, a single candidate incident as it may be likely that the detected events are related. For example, arguments or incidents occurring between seats on the vehicle. Similar events that cross between sensors associated with adjacent locations may be combined into a single event, for example, object crossing between seats. As another example, if the two events are temporally related (e.g., occurring within a set amount of time), the events may be combined into a single event. For example, an object throw from a first location that results in an incident in a second location, arguments occurring between student passengers situated with multiple rows of seats between each passenger, etc.

In some implementations, a plurality of sensor types may be utilized to detect events. For example, an audio sensor may detect a first audio event, while a motion sensor may detect a motion event. The audio event and motion event may be combined into a single event in the case where the events are related. For example, a motion event may be detected in the case of a thrown object, while an audio event may be detected in the form of increased nose. If the two events occur within a set amount of time, process 900 may determine the two events are related as a thrown object and a victim of the object reacting to the object. As another example, fighting and shouting events may be correlated based on temporal relationships.

In some implementations, a detected event can be classified as a candidate incident based on whether or not the vehicle is moving (e.g., traveling along a route). For example, a sensor may detect movement within an associated area, which may be recognized as a student exiting a seat (e.g., standing up). Recognition may be through object detection and recognition techniques. The detected movement event may only be a candidate incident if the school bus is move, for example, a student is standing while the bus is in motion. Otherwise the movement event may be acceptable, such as when the bus is parked and students are entering or exiting the bus. As such, the movement event may be classified as a candidate incident only if a determination is made that the bus was moving. For example, incident detection circuit 210 may determine the bus is traveling along a route based on signals from sensors 252 (e.g., vehicle speed sensors 220) or vehicle systems 258 (e.g., vehicle positioning system 272). If the incident detection circuit 210 determines the bus is stationary, the detected event may be dropped (e.g., ignored), but if the incident detection circuit 210 detects movement of the bus the detected event may be classified as a candidate incident of standing on a moving bus. In another example, sensors may be active or inactive based on whether or not the bus is moving.

The above scenarios are provided as examples for illustrative purposes, and are not intended to limit the scope of the present disclosure. One skilled in the art would recognize the multitude of different scenarios that may occur within a school bus environment.

At block 908, one or more student passengers may be identified as a suspected participant of the candidate incident based, in part, on the determined location within the interior of the vehicle. For example, one or more student passengers may be seated on seat 114 within the identified location, and identified as suspected participants based on seated position. In another example, facial recognition of image data may be used to identify student passengers, where the location identified in block 906 is used to locate the student within the image data (e.g., by seat). The facial recognition can be checked against images of student passengers stored in 322, which may be included in student table 524. In another example, database 322 may store assigned seating arrangements that designates a particular seat to a particular student passenger. In this case, incident detection circuit 210 may retrieve the assigned seating arrangement and correlate the location identified in block 906 to a seating assignment stored in the database, and identifying the student assigned to the seat at the location as a suspected participant. In yet another example, names of student passengers may be recognized and extracted from audio events, using natural language processing. Based on timestamps attached to the data, names detected within a period of time from the occurrence of a detected event may be associated with the event as a suspect participants. The names may be checked against a listing of students passengers associated with the route and/or vehicle to confirm that the detected name is a student that would have been present in the vehicle.

Blocks 910 and 912 represent optional blocks as shown by the dotted lines, which may be performed by the incident detection circuit 210 and/or incident management system 320. At block 910, an incident resolution action may be generated for the candidate incident. At block 912, the incident resolution action can be transmitted to end-user devices communicatively coupled to incident detection system for resolving the candidate incident. For example, a recommendation of an incident resolution action plan may be generated and provided, as described above in connection with FIG. 8.

Process 900 may also include, either as part of block 910 or between block 908 and blocks 910, generating an incident report based on the candidate incident from block 904, the determined location from block 906, and the identified suspected participants from block 908. For example, as described above in connection with FIG. 8, data representing the candidate incident, the determined location, and the identified suspected participants may be used by incident detection circuit 210 to populate data fields of an incident report, which can be uploaded to incident management system 320 for further processing. In another example, the data representing the candidate incident, the determined location, and the identified suspected participants may be uploaded to incident management system 320 for further use in populating data fields of an incident report, either by end-users and/or the incident management system 320 itself.

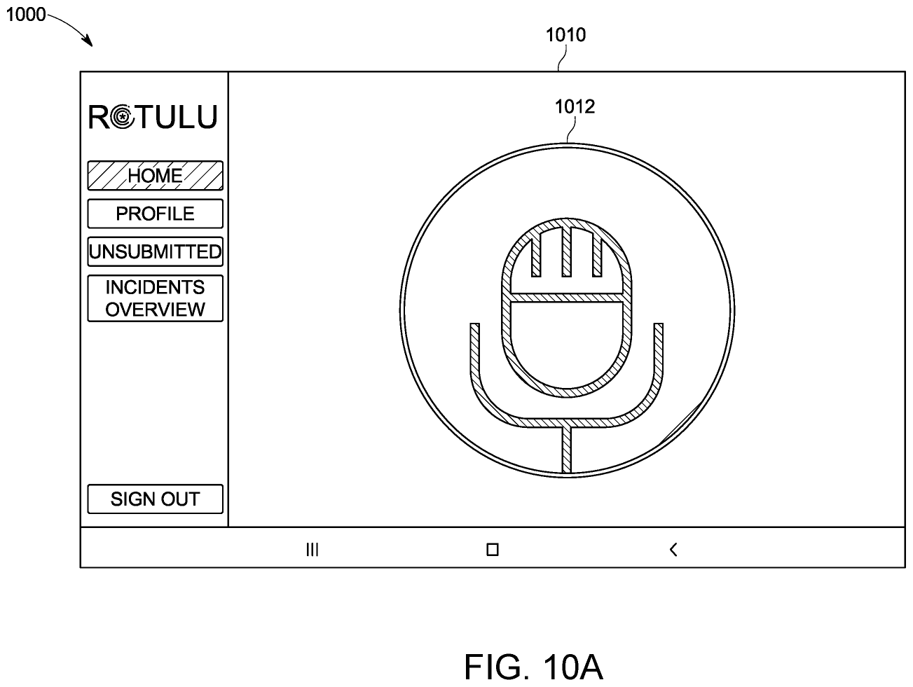

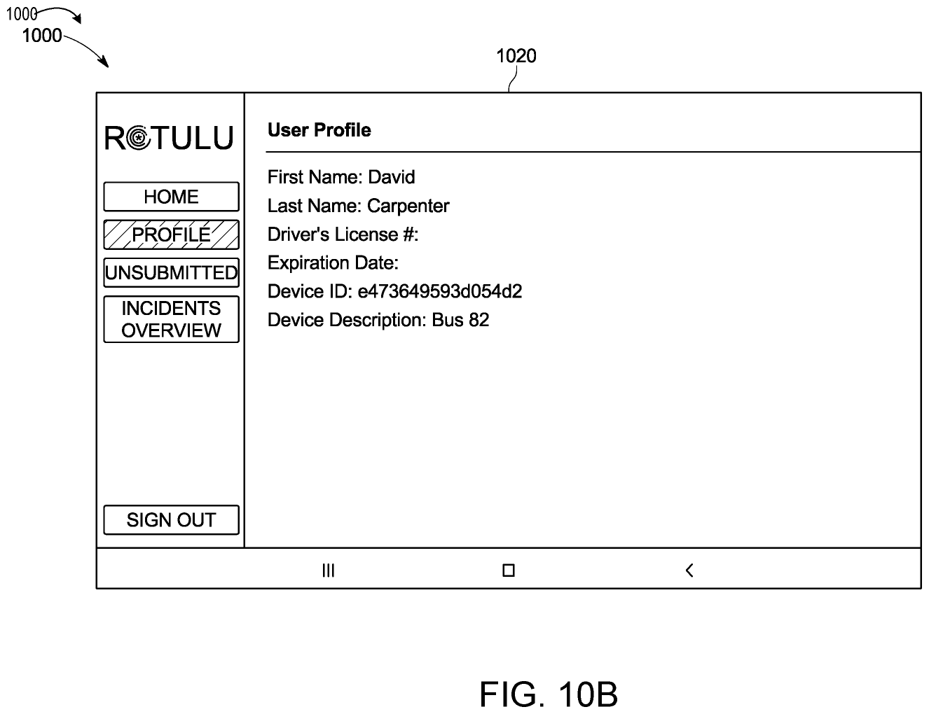

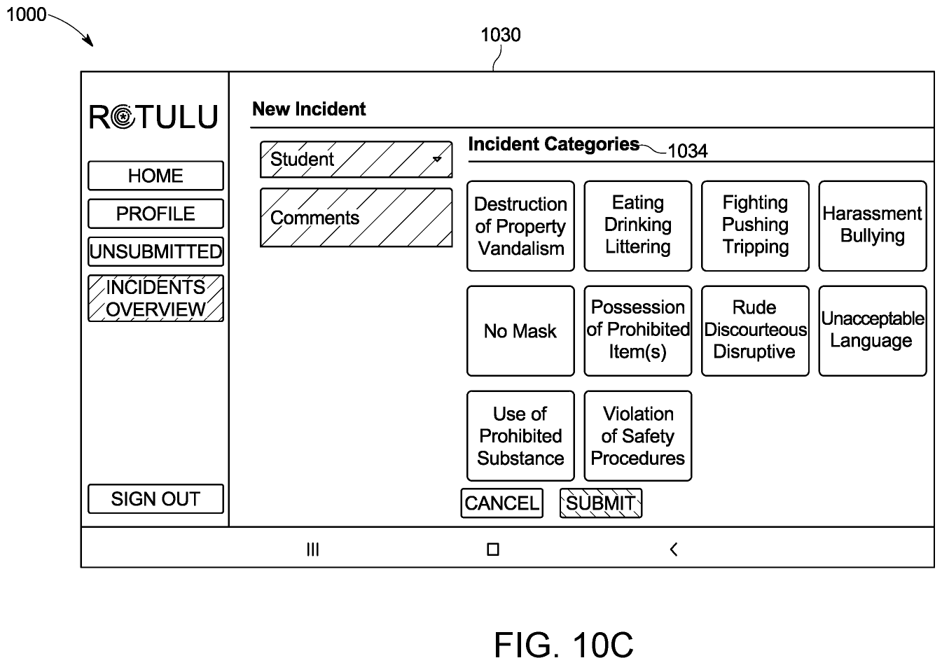

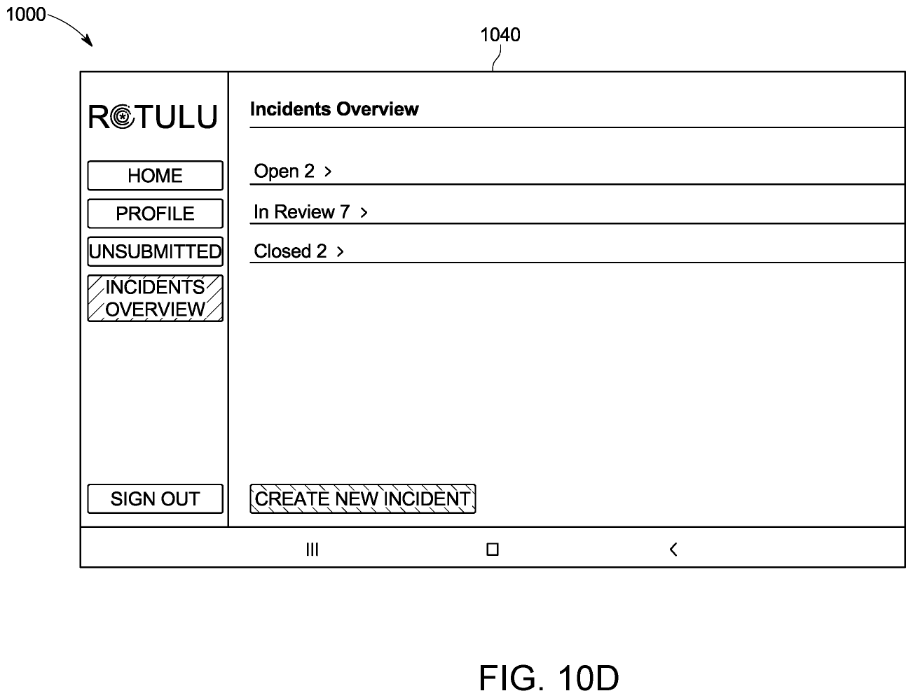

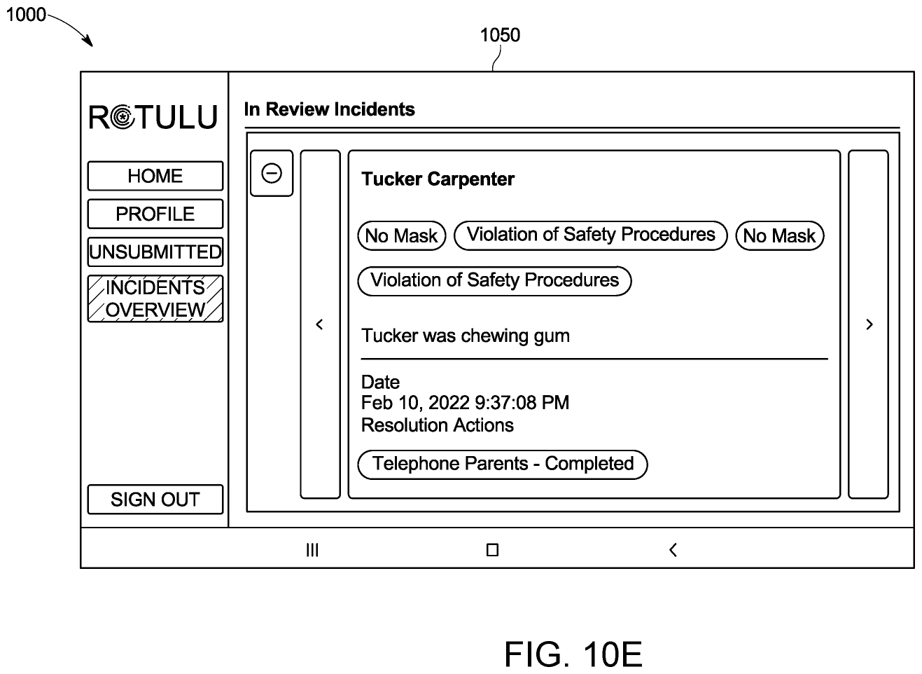

FIGS. 10A-10E illustrate screen shots of an example graphical user interface (GUI) 1000 that may be generated in accordance with embodiments disclosed herein. For example, GUI 1000 may be generated by incident management system 320 and displayed on end-user devices 330, such as through one of webapp interfaces 325, 326, and/or 328. In various embodiments, the GUI 1000 may be used for accessing, viewing, creating, and editing incident reports and incident resolution action plans in accordance with embodiments disclosed herein. GUI 1000 comprises a plurality of display screens, examples of which are FIGS. 10A-10E, that may be generated by incident management system 320 and displayed on an end-user device 330. In the case of examples shown in FIG. 10A-10E, the end-user devices 330 may be a tablet, smart phone, or interaction system of a vehicle (e.g., heads up display comprising a touchscreen).

FIG. 10A graphically illustrates a home screen 1010 (also referred to as a main operation screen) of GUI 1000. Home screen 1010 may be displayed responsive to a user login into and successful authentication by the incident management system 320 (e.g., as described above in connection with FIG. 4). Upon first login into the GUI 1000, an incident Management feature flag is set to true (e.g., thereby enabling the incident management features offered by the incident management system) and a Routing feature flag is set to false (e.g., routing feature functionality not enabled, thus inactive). These flag settings may be an default configuration upon login; however, other defaults may be used (e.g., incident management feature flag set to false and routing flag set to true, both set to true, both set to false, etc.). The center of the home screen 1010 may include an access button 1012 that may be activated by user interaction, such as a double tap or long press. In the example of FIG. 10A, the access button 1012 may have size that is large enough to permit a driver of a vehicle to activate the access button 1012 without removing the drivers attention away from the operation of the vehicle.

In some embodiments, interacting with access button 1012 may trigger creation of a student incident report for later action. For example, pressing access button 1012 may tags a candidate incident for subsequent actions by the driver. In an illustrative example, the vehicle incident detection circuit 210 may classify a candidate incident as described above, and user interaction with access button 1012 may tag the classified candidate incident for subsequent review and acknowledgment, for example, prior to transmission to incident management system 320. In another example, a blank incident report may be created and tagged, which the driver may populate with relevant data at a later time. The action of tagging creates a new Student Incident Report, including a timestamp. In some embodiments, GPS coordinates may be included based on a current GPS coordinate of the vehicle when the access button 1012 is activated. Tagging may not initiate any lifecycle actions (e.g., FIG. 8), as a candidate incident may be deleted or further edited prior to submission.

In some embodiments, if Routing is also active, the button 1012 may be present on the screen and much smaller so as to not interfere with a map view. For example, Routing may include displaying a map of a bus route, with a position of the bus displayed thereon (e.g., GPS or vehicle positioning system 272). In this case, the map view may be displayed with access button 1012 presented at a reduced size as compared to that shown in FIG. 10A.

In some embodiments, user interactions may include voice commands, for example, in place of physical interaction with access button 1012. As another example, voice-to-text and natural voice processing techniques may be utilized to convert spoken incident details to an incident report. For example, a voice-to-text process permits a vehicle operator to create notes about a candidate incident while driving to summarize details. The incident detection circuit 210 installed on the vehicle (or incident management system 320) may be configured to categorize the text, match the text to likely incident types and categories, and extract suspected student participants through name recognition and categorization.

For example, a vehicle operator may see something while driving and double taps access button 1012 (or use voice commands to active the access button 1012). GUI 1000 is then triggered to create a new incident report. The operator may then say “Jimmy Johnson got out of his seat and walked 2 seats up to take something from Johnny Jones while the bus was moving,” or similar free-form description. The GUI 1000 detects that the operator is done speaking, stops recording, and returns to the home screen 1010. In some embodiments, a plurality of recordings may be stitched together to provide a long term format, such as a continuous comment detected event. For example, an operator may provide detail comments, which may be broken into snippets or segments of detected speech. The GUI 1000 may detect that the comment segments are related, for example, by explicit reference, detecting similar names or context using natural language processing, etc. The related segments may be combined in a logical order (e.g., by timestamp, context, or a combination thereof) to provide a long term format that includes the comments as a continuous description. In the background, the GUI 1000 (e.g., incident detection circuit 210 and/or incident management system 320) creates an incident report with the voice to text comments and tags the incident with a timestamp and with GPS coordinates (in some examples).

As another example, a new incident report may be triggered in GUI 1000 automatically, for example, based on one or more sensors within the vehicle (e.g., passenger sensors 116 and/or door sensor 120) detecting an event. In an embodiment, multiple events detected using one or more sensors may be combined to provide a long term format of a continuous event comprising the multiple events. For example, in the case of audio sensors, a plurality of individual events may be detected and the GUI 1000 may determine these events are related. For example, repeated threatening language, trip of a drug sensor (e.g., smoke detector or the like), and so on may be considered related. GUI 1000 may detect seemingly separate events are related, for example, based on similar context, voice recognition (e.g., identify a single speaker based on a detected voice), and so on. The GUI 1000 may then combine the multiple events into a single event, and trigger an incident report, including populating the incident report with description of the multiple events as a single, continuous event. That is, process 900 may trigger a generating a new incident report by the GUI 1000 responsive to block 902. The GUI 1000 may perform blocks 904-908 as described above and generate a new incident accordingly. The new incident may be tagged with the a timestamp and GPS coordinates as set forth above.

Later, such as when the vehicle is parked, the operator (or another end-user) may access the incident via an Incident Overview Screen (e.g., FIG. 10C). From the Incident View Screen, the incident report may be reviewed, including any comments entered. Further, the incident report may be updated if the system did not categorize the incident correctly, flags the wrong student, or did not accurately convert the spoken comments to text.

The end-suer may then submit the incident report and trigger process 800. The end-user may also be given an option to cancel the incident submission, for example, if they feel the incident does not warrant action after review. In some embodiments, if an incident is not submitted within a certain time (e.g., midnight of the creation day), the incident report may be removed from a queue of reports. In another embodiments, unsubmitted reports may be reviewed by incident management system 320 and submitted based on category (e.g., if sever enough to warrant submission, such as lethal weapons or illegal substances). In another embodiment, unsubmitted incidents may be auto submitted, for example, when the vehicle enters a geofence area (e.g., enters a geofence area of a school or bus depot). In some case, auto submission may occur after alerting the end-user that unsubmitted incidents will be submitted if the operator doesn't initiate review within a set amount of time (e.g., 5 minutes, 10 minutes, etc.). Unsubmitted incidents may be saved in incident management system 320 for further analysis and pattern recognition, for example, to learn which incident types warrant submission or not.

Home screen 1010 may comprise links that allow the end-user to navigate to a Profile Screen (e.g., FIG. 10B), Unsubmitted Incidents Screen (e.g., FIG. 10C), and Incident Overview Screen (e.g., FIG. 10D). In some embodiments, navigation to these additional screens is restricted based on movement of the vehicle. For example, an operator may not be permitted to navigate to the other screens when the vehicle is in motion, instead only when the is parked is the navigation permitted.

As noted above, FIG. 10B graphically illustrates a profile screen 1020 of GUI 1000. Profile screen 1020 may be displayed responsive to an end-user (e.g., vehicle operator in some examples) interacting with the profile link on home screen 1010. Profile screen 1020 displays basic information about the logged in end-user and allows them to edit the information. It also lets the end-user update information, such as operator's license expiration date. The device ID may identify the vehicle assigned to the end-user, in this case the a bus operator.

FIG. 10C graphically illustrates an unsubmitted incident screen 1030 of GUI 1000. Unsubmitted incident screen 1030 may be displayed responsive to an end-user (e.g., vehicle operator in some examples) interacting with the unsubmitted link of home screen 1010. In some embodiments, the unsubmitted incident screen 1030 may be accessed for reviewing, editing, deleting, and/or submitted a candidate incident.

The unsubmitted incident screen 1030 includes a comments region, which may be populated with end-user comments, such as, voice-to-text comments described above and/or comments entered directly by an end-user during a review process. As described above, GUI 1000 may categorize the comments, for example, by selecting one or more of incident categories 1034. The selected incident categories may be by highlighted or otherwise comprise a visual appearance that is altered relative to the unselected categories. Thus, when an end-user access the unsubmitted incident screen 1030 later, the end-user may easily review the selected categories and modify the selection as desired.

Unsubmitted incident screen 1030 also includes a student region. In the example of FIG. 10C, the student region is provided as a drop down menu in which tagged students may be listed by student name. The student names listed may be extracted, for example, from the comments region (or from voice-to-text as described above) and auto populated in the drop down menu. From the drop down menu, an end-user may review, add, or delete students names as necessarily to ensure the correct students are identified.

Unsubmitted incident screen 1030 includes a cancel button and submission button for either deleting the incident or submitting the incident to the incident management system 320.

FIG. 10D graphically illustrates an incident overview screen 1040 of GUI 1000. Incident overview screen 1040 may be displayed responsive to an end-user (e.g., vehicle operator in some examples) interacting with the incident overview link on home screen 1010. The incident overview screen 1040 may include a list of incidents created by the end-user, sorted by date and life cycle status (e.g., open/pending, closed/resolved, in review, etc.). An example of the order may be: incidents created but not submitted listed newest to oldest per timestamps; incidents resolved but not acknowledged by the end-user listed from newest to oldest per timestamp of when resolved; incidents submitted but in review (e.g., not acknowledged by another end-user, such as an administrator) listed from newest to oldest; incidents acknowledged but not resolved listed from newest to oldest; and incidents that are resolved or complete (e.g., acknowledged by the end-user who created the original incident) listed from newest to oldest.

In the example shown in FIG. 10D, an end-user may select a status, which expands a dropdown list of incidents having the selected status. When an end-user selects a particular incident from the dropdown list, an incident details screen (e.g., FIG. 10E) for that incident may be generated and displayed. From the incident details screen an end-user may perform specific actions and see details for the selected incident.

Incident overview screen 1040 may also include a create new incident button. User interaction with the create new incident button generates a new incident report and tags the report with a GPS location and Timestamp using a current location and time. An incident details screen may be displayed to permit the end-user to enter details and submit the new incident.

FIG. 10E graphically illustrates an incident detail screen 1050 of GUI 1000. Incident detail screen 1050 displays detailed information for each stage of an incident report. An end-user may use incident detail screen 1050 to fill out details and comments for the incident and submit it. In some embodiments, incident detail screen 1050 may be auto populated using voice-to-text as described above. That is, for example, responsive to activating access button 1012 and creating a new incident report, incident detail screen 1050 may be populated using the details entered. Then when the end-user navigates to 1050 through incident overview link, the end-user may review and edit the details that were auto populated. The end-user can also delete the incident at this stage.

Incident detail screen 1050 may display all life cycle stages of the incident (e.g., status through process 800). Actions taken for each stage, along with notes at each stage, may be displayed as well. Once all actions are complete, the operator may have an optional comment section and an “acknowledge” button at the bottom of the screen to complete the life cycle.

End-users who are not vehicle operators may also access incident management system 320, for example, through one of webapp interfaces 325, 326, or 328 executed as web portal running on a web browser. Thus, other end-users may be able to create, view, and track incident reports and resolutions therefore through incident management system 320. The webapp interfaces used by non-vehicle operator end-users may generate a GUI that is substantially similar to GUI 1000, such that similar screens can be displayed at end-user devices accessing the incident management system 320 via any webapp interface.

As described above, the incident management system 320 may be governed by organization membership and roles. Thus, when an end-user logs in and selects an organization to view, the GUI navigation options can be customized for each end-user based on assigned roles in the selected Organization. For example, if an end-user has the role Incident Creator in an Organization and they select the “Incident Management” view, the screen displayed will be similar to incident detail screen 1050.

Embodiment disclosed herein provide for a parent web portal (e.g., one of webapp interfaces 325, 326, or 328 executed on an end-user device operated by a parent). Through the parent web portal responsibility of registering a student's transportation needs may be transferred from the school to the parent or student. Through the parent web portal, a communication platform may be established that can be leveraged to inform parents/students on the bus schedule and events. A parent can enter information for their student manually and/or look them up in the system the student they already exist.

In an example, an administrator can perform a validation on the parents request for transportation if needed. In this scenario, the parent end-user can create an account, enter (and/or search for) their dependent student and be placed into a “pending” status. An administrator may be alerted and requested to validate that the information for the student.

Candidate incidents according to some embodiments may be malfunctions or concerns with the vehicle operation. In this case, the incident management system 320 can send incident to a bus maintenance administrator. Incidents can be resolved by the maintenance administrator, and collected as data for model training. The model may be able to tag similar events recognized that lead up to a failure incident and notify maintenance administrators of the probability of a similar failure incident for the vehicle. When a maintenance event is recognized that is likely to lead to a failure incident, the incident management system 320 may be configured to order the parts necessary to resolve that event, and schedule time to bring the vehicle in for remedial action. Incident management system 320 may also update routing solutions assignments with a substitute vehicle or cross load passenger as needed responsive to an out of service vehicle.

Candidate incidents according to some embodiments may be incidents resulting from equipment accidents. Information may be gathered on the equipment leading up to an accident, and sorted to simplify reports to law enforcement, and insurance when necessary. Accident information as data collected on equipment, operator, environment, and passengers to build a predictive model to assign a probability of the equipment resulting in accident over time. This probability may be used to adjust variables to reduce the overall probability of an accident.

Candidate incidents according to some embodiments may be technical Incidents related to technical bugs or inquiries. In this case, incident management system 320 may recognize these incidents and send them to be analyzed by engineers and/or algorithms to improve platform stability and user experience. Engineers may be assigned to incidents in real time to address customer needs.

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 11. Various embodiments are described in terms of this example-computing component 1100. After reading this description, it will become apparent to a person skilled in the relevant art how to implement the application using other computing components or architectures.

Referring now to FIG. 11, computing component 1100 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 1100 might also represent computing capabilities embedded within or otherwise available to a given device. For example, a computing component might be found in other electronic devices such as, for example, portable computing devices, and other electronic devices that might include some form of processing capability.

Computing component 1100 might include, for example, one or more processors, controllers, control components, or other processing devices. This can include a processor, and/or any one or more of the components making up network architecture 300a of FIG. 3A or network architecture 300a 3B, such as incident detection circuit 210 of FIG. 2, server 321 of FIG. 3A or 3B, and/or end-user devices 330 FIG. 3A or 3B. Processor 1104 might be implemented using a general-purpose or special-purpose processing engine such as, for example, a microprocessor, controller, or other control logic. Processor 1104 may be connected to a bus 1102. However, any communication medium can be used to facilitate interaction with other components of computing component 1100 or to communicate externally.

Computing component 1100 might also include one or more memory components, simply referred to herein as main memory 1108. For example, random access memory (RAM) or other dynamic memory, might be used for storing information and instructions to be executed by processor 1104. For example, 1108 may store instructions for executing operations described in connection with FIGS. 4, 8, and/or 9. As another example, memory 1108 may store instructions for executing GUI 1000 or the like. Main memory 1108 might also be used for storing temporary variables or other intermediate information during execution of instructions to be executed by processor 1104. Computing component 1100 might likewise include a read only memory (“ROM”) or other static storage device coupled to bus 1102 for storing static information and instructions for processor 1104.

The computing component 1100 might also include one or more various forms of information storage mechanism 1110, which might include, for example, a media drive 1112 and a storage unit interface 1120. The media drive 1112 might include a drive or other mechanism to support fixed or removable storage media 1114. For example, a hard disk drive, a solid-state drive, a magnetic tape drive, an optical drive, a compact disc (CD) or digital video disc (DVD) drive (R or RW), or other removable or fixed media drive might be provided. Storage media 1114 might include, for example, a hard disk, an integrated circuit assembly, magnetic tape, cartridge, optical disk, a CD or DVD. Storage media 1114 may be any other fixed or removable medium that is read by, written to or accessed by media drive 1112. As these examples illustrate, the storage media 1114 can include a computer usable storage medium having stored therein computer software or data.

In alternative embodiments, information storage mechanism 1110 might include other similar instrumentalities for allowing computer programs or other instructions or data to be loaded into computing component 1100. Such instrumentalities might include, for example, a fixed or removable storage unit 1122 and an interface 1120. Examples of such storage units 1122 and interfaces 1120 can include a program cartridge and cartridge interface, a removable memory (for example, a flash memory or other removable memory component) and memory slot. Other examples may include a PCMCIA slot and card, and other fixed or removable storage units 1122 and interfaces 1120 that allow software and data to be transferred from storage unit 1122 to computing component 1100.

Computing component 1100 might also include a communications interface 1124. Communications interface 1124 might be used to allow software and data to be transferred between computing component 1100 and external devices. Examples of communications interface 1124 might include a modem or soft modem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 1124 may be carried on signals, which can be electronic, electromagnetic (which includes optical) or other signals capable of being exchanged by a given communications interface 1124. These signals might be provided to communications interface 1124 via a channel 1128. Channel 1128 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 1108, storage unit 1120, media 1114, and channel 1128. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 1100 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. An incident detection system for a school bus, the incident detection system comprising:
a plurality of sensors disposed within an interior of the school bus, each sensor of the plurality of sensors configured to detect events within an area of the interior associated with each sensor, wherein the interior is configured to carry student passengers; and
a processor coupled to a memory storing instructions, the processor configured to execute the instructions to:
detect an event within the interior using at least a first sensor of the plurality of sensors, the detected event comprising one or more characteristics;
classify the detected event as a candidate incident based on at least one characteristic of the one or more characteristics exceeding a threshold value;
responsive to detecting the event, determine a location within the interior for the candidate incident as an area associated with the first sensor;
identify one or more student passengers as suspected participants of the candidate incident based, in part, on the determined location within the interior;
generate an incident resolution action for the candidate incident; and
transmit the incident resolution action to end-user devices communicatively coupled to the incident detection system for resolving the candidate incident.

2. The incident detection system of claim 1, wherein each area of the interior comprises a seat of a plurality of seats included in the interior of the school bus.

3. The incident detection system of claim 1, wherein each area of the interior comprises a row of seats of a plurality of rows of seats included in the interior of the school bus.

4. The incident detection system of claim 1, wherein each area of the interior comprises a column of seats of a plurality of columns of seats included in the interior of the school bus.

5. The incident detection system of claim 1, wherein the plurality of sensors comprises a plurality of audio sensors configured to detect audio events emitted from areas associated with the audio sensors.

6. The incident detection system of claim 5, wherein the one or more characteristics of an audio events comprise an amplitude and a frequency, wherein the processor is further configured to:
classify a detected audio event as a candidate incident in response to at least one of: an amplitude of the detected audio event exceeding a threshold amplitude and a frequency of the detected audio event exceeding a threshold frequency.

7. The incident detection system of claim 1, wherein the plurality of sensors comprises a plurality of motion sensors configured to detect movement events occurring within areas associated with the motion sensors.

8. The incident detection system of claim 7, wherein the one or more characteristics of a movement event comprise one or more of a velocity of an object, acceleration of an object, and direction of movement of an object, wherein the processor is further configured to:
classify a detected movement event as a candidate incident in response to at least one of: a velocity of an object exceeding a threshold velocity, an acceleration of an object exceeding a threshold velocity, and a direction of movement of the object traversing away from one of the suspected participants,
wherein the object is a body part of the suspected participant or an item having a direction of movement that originating from the student passenger source.

9. The incident detection system of claim 8, wherein the processor is further configured to classify the detected movement event as a candidate incident based on the school bus is traveling along a route.

10. The incident detection system of claim 1, wherein the plurality of sensors comprises a plurality of visual sensors configured to capture image data of corresponding areas, wherein the processor is further configured to recognize motion event from the captured image data.

11. The incident detection system of claim 1, wherein the processor is further configured to generate an incident report by automatically populating fields of an incident report based on the identified student passenger and the candidate incident.

12. The incident detection system of claim 11, wherein the plurality of sensors comprises a plurality of audio sensors configured to detect audio events emitting from corresponding areas, wherein the processor is further configured to:
detect a name of one or more of the suspected participants from the detected audio event using natural language processing; and
generate the incident report based on the detected name and the determined location.

13. The incident detection system of claim 1, wherein the processor is further configured to:
correlate the determined location with the interior to a seating assignment database that includes assigns student passengers to the areas within the interior,
wherein identifying the suspected participants is based on the correlation.

14. A method for detecting incidents on a school bus, the method comprising:
detecting an event within an interior of a school bus using at least a first sensor of a plurality of sensors disposed within the interior of the school bus, the detected event comprising one or more characteristics, wherein each sensor of the plurality of sensors is associated with an area of the interior;
categorizing the detected event as a candidate incident based on at least one characteristic of the one or more characteristics exceeding a threshold value;
responsive to detecting the event, determining a location within the interior for the candidate incident as an area associated with the first sensor;
identifying one or more student passengers as suspected participants of the candidate incident based, in part, on the determined location within the interior;
generating an incident resolution action for the candidate incident; and
transmitting the incident resolution action to end-user devices for resolving the candidate incident.

15. The method of claim 14, wherein each area of the interior comprises a seat of a plurality of seats included in the interior of the school bus.

16. The method of claim 14, wherein each area of the interior comprises at least one: of row of seats of a plurality of rows of seats included in the interior of the school bus, and a column of seats of a plurality of columns of seats included in the interior of the school bus.

17. The method of claim 14, wherein the plurality of sensors comprises a plurality of audio sensors configured to detect audio events emitted from areas associated with the audio sensors, wherein the one or more characteristics of an audio events comprise an amplitude and a frequency, wherein the method further comprises:
categorizing a detected audio event as a candidate incident in response to at least one of: an amplitude of the detected audio event exceeding a threshold amplitude and a frequency of the detected audio event exceeding a threshold frequency.

18. The method of claim 14, wherein the plurality of sensors configured to detect movement events occurring within areas associated with the sensors, wherein the one or more characteristics of a movement event comprise one or more of a velocity of an object, acceleration of an object, and direction of movement of an object, wherein the method further comprises:
categorizing a detected movement event as a candidate incident in response to at least one of: a velocity of an object exceeding a threshold velocity, an acceleration of an object exceeding a threshold velocity, and a direction of movement of the object traversing away from one of the suspected participants.

19. The method of claim 14, further comprising:
generate an incident report by automatically populating fields of an incident report based on the identified student passenger and the candidate incident.

20. A non-transitory computer-readable storage medium having stored thereon executable computer program instructions that, when executed by one or more processors, cause the one or more processors to perform operations comprising:
generating graphical user interface (GUI) on a first device in a school bus;
creating an incident report responsive to an input into the GUI, the incident report indicative of a candidate incident related to the school bus and comprising a created by identifier representative of the input and a timestamp;
generating an incident resolution action for the candidate incident and appending the incident resolution action to the incident report; and
transmitting the incident report to a second device communicatively for resolving the candidate incident based on the incident resolution action.
